(19) United States
(12) Patent Application Publication
(10) Pub. No.: US 2025/0252717 A1
(43) Pub. Date: Aug. 7, 2025

(54) METHOD AND SERVER FOR TRAINING OBJECT DETECTOR

(71) Applicant: HUAWEI TECHNOLOGIES CO., LTD., Shenzhen (CN)

(72) Inventors: Guile WU, Kanata (CA); Tongtong CAO, Kanata (CA); Bingbing LIU, Shenzhen (CA)

(21) Appl. No.: 19/189,612

(22) Filed: Apr. 25, 2025

Related U.S. Application Data
(63) Continuation of application No. PCT/CN2023/078328, filed on Feb. 27, 2023.

(51) Int. Cl. G06V 10/774; G06V 10/82; G06V 20/64

(52) U.S. Cl. CPC G06V 10/774; G06V 10/82; G06V 20/64

(57) ABSTRACT

A method and server for training an Object Detector (OD) to detect objects in 3D point clouds are provided. The method comprises: during a first stage of a training pipeline: training the OD using a source domain dataset to detect the objects in a source domain, thereby generating a first trained OD; during a second stage of the training pipeline: training the first trained OD using a target domain dataset to detect the objects in a target domain, thereby generating a second trained OD; and during a third stage of the training pipeline: generating, based on the source domain dataset and the target domain dataset, a cross-domain dataset; and training the second trained OD using the cross-domain dataset to detect objects in both the source domain and the target domain, thereby generating a cross-domain OD.

### CROSS-REFERENCES TO RELATED APPLICATIONS

This application is a continuation of International Application No. PCT/CN 2023/078328, filed Feb. 27, 2023, which is hereby incorporated by reference in its entirety.

### TECHNICAL FIELD

The present technology relates broadly to object detection; and more specifically, to a method and server for training an object detection model for detecting objects in multiple domains.

### BACKGROUND

Optimizing a given object detection model for detecting objects based on data of multiple domains (such as that generated in different geographical locations or in different weather conditions) can be costly and lack scalability. For example, such optimization may require comparatively large training datasets from each domain that have been labelled by human assessors, which can be expensive and inefficient.

Thus, it is desired to train a cross-domain object detection model reducing the involvement of the human assessors in the preparation of the training datasets.

Certain prior art approaches have been proposed to address the above-identified technical problem.

An article entitled “TOWARDS UNIVERSAL OBJECT DETECTION BY DOMAIN ATTENTION”, authored by Wang et al., and published by University of California, San Diego, on Jul. 6, 2019, discloses training a universal RGB image-based 2D object detector capable of operating over multiple domains.

An article entitled “DOMAIN-INVARIANT DISENTANGLED NETWORK FOR GENERALIZABLE OBJECT DETECTION”, authored by Lin et al., and published in the proceedings of the 2021 IEEE/CVF International Conference on Computer Vision (ICCV), discloses a domain-invariant disentangled network to learn a RGB image-based 2D generalizable object detector.

An article entitled “UNIVERSAL REPRESENTATION LEARNING FROM MULTIPLE DOMAINS FOR FEW-SHOT CLASSIFICATION”, authored by Li et al., and published by University of Edinburgh on May 25, 2021, discloses training a classifier to be generalized to previously unseen classes and domains from few labeled samples by training universal deep representations via distilling knowledge of multiple pre-trained networks.

### SUMMARY

It is an object of the present technology to ameliorate at least one inconvenience associated with the prior art.

Embodiments of the present technology have been developed based on developers' appreciation of shortcomings associated with the prior art. More specifically, the developers of the present technology have noted that although there have been some cross-domain 3D object detection methods, they mostly focus on adapting a model trained based on source domain data to new target domain data but fail to maintain the performance on the source domain data. This may result in a bias towards the target domain data and poor performance on the source domain data.

Also, as it can be appreciated from the above prior art review, in the tasks of image classification, there have been works devised to realize domain generalization for visual recognition. However, these methods appear to be capable of addressing the problem only for the RGB images and cannot be used in the LiDAR-based 3D object detection, for example. Furthermore, these methods are directed to training a generic object detector from multiple domains, which typically requires all training data be labelled.

Thus, the developers have devised a specific training pipeline of a cross-domain object detector (OD) using multiple domain data and transferring feature representations of objects across the multiple domains during the training. This may hence allow reducing the amount of labelled data required for the training and increasing the overall accuracy of the object detection.

More specifically, in accordance with a first broad aspect of the present technology, there is provided a computer-implementable method for training an Object Detector (OD) to detect objects in 3D point clouds. The method is executable by a server including a processor. The method comprises: during a first stage of a training pipeline: training, by the processor, the OD using a source domain dataset to detect the objects in a source domain, thereby generating a first trained OD, the source domain dataset comprising a first plurality of training 3D point clouds and corresponding training labels. Further, during a second stage of the training pipeline, the method comprises: training, by the processor, the first trained OD using a target domain dataset to detect the objects in a target domain, thereby generating a second trained OD, the target domain dataset comprising a second plurality of training 3D point clouds and the corresponding training labels. Further, during a third stage of the training pipeline, the method comprises: generating, by the processor, a cross-domain dataset using at least one 3D point cloud and the corresponding training label from the source domain dataset and at least one 3D point cloud and the corresponding training label from the target domain dataset; and training, by the processor, the second trained OD using the cross-domain dataset to detect objects in both the source domain and the target domain, thereby generating a cross-domain OD.

In some implementations of the method, during the first stage of the training pipeline, the method further comprises: acquiring, by the processor, an other source domain dataset from an other source domain, different from the source domain; generating, by the processor, a combined source domain dataset including at least one training 3D point cloud from the source domain dataset and at least one training 3D point cloud from the other source domain dataset; and the generating the first trained OD comprises training the OD using the combined source domain dataset to detect the objects in each one of the source domain and the other source domain.

In some implementations of the method, during the second stage of the training pipeline, prior to the training, the method comprises: acquiring, by the processor, an unlabelled target domain dataset including a third plurality of training 3D point clouds devoid of the corresponding training labels; feeding, by the processor, each training 3D point cloud of the unlabelled target domain dataset to the first trained OD to generate, for each training 3D point cloud of the unlabelled target domain dataset, a corresponding training pseudo label, thereby generating a pseudo-labelled target domain dataset; generating, by the processor, a combined target domain dataset including at least one training 3D point cloud and the corresponding training label from the target domain dataset and at least one training 3D point cloud and the corresponding training pseudo label from the pseudo-labelled target domain dataset; and the generating training the second trained OD comprises training, by the processor, the first trained OD using the combined target domain dataset for detecting the objects in the target domain.

In some implementations of the method, the generating the second trained OD comprises training the first trained OD using both (i) the combined target domain dataset; and (ii) at least one training 3D point cloud data and the corresponding label from the source domain dataset to detect the objects in the target domain.

In some implementations of the method, during the first stage of the training pipeline, the method further comprises: acquiring, by the processor, an other source domain dataset from an other source domain, different from the source domain; generating, by the processor, a combined source domain dataset including at least one training 3D point cloud from the source domain dataset and at least one training 3D point cloud from the other source domain dataset; and the generating the second trained OD comprises training the first trained OD using both (i) the combined target domain dataset; and (ii) at least one training 3D point cloud data and the corresponding label from the combined source domain dataset to detect the objects in the target domain.

In some implementations of the method, the OD comprises: (i) a feature extractor configured to generate, based on a given 3D point cloud fed thereto, a respective feature map representative of at least one object captured by the given 3D point cloud; and (ii) a detection head to be trained to detect, based on the respective feature map, the at least one object captured by the given 3D point cloud.

In some implementations of the method, the OD is a CenterPoint-based neural network.

In some implementations of the method, during the first stage of the training pipeline, the method further comprises: training, by the processor, the OD using the source domain dataset for detecting the objects in the source domain, thereby generating a trained source domain-specific OD; acquiring, by the processor, an other source domain dataset from an other source domain, different from the source domain; training, by the processor, an other OD using the other source domain dataset for detecting the objects in the other source domain, thereby generating an other trained source domain-specific OD; generating, by the processor, a combined source domain dataset including at least one training 3D point cloud from the source domain dataset and at least one training 3D point cloud from the other source domain dataset; and the generating the first trained OD comprises training the OD using the combined source domain dataset to detect the objects in each one of the source domain and the other source domain; during the third stage of the training pipeline, prior to the training, the method comprises: generating, by the processor, for a given training 3D point cloud from the cross-domain dataset, a plurality of domain-specific feature maps by applying to the given training 3D point cloud the feature extractors of each one of the trained source domain-specific OD and the other source domain-specific OD; generating, by the processor, for the given training 3D point cloud from the cross-domain dataset, a cross-domain feature map by applying, by the processor, to the given training 3D point cloud the feature extractor of the second trained OD; and wherein the training the second trained OD, thereby generating the cross-domain OD, is further based on a comparison between the cross-domain feature map and each one of the plurality of domain-specific feature maps.

In some implementations of the method, during the third stage of the training pipeline, prior to the generating the plurality of domain-specific feature maps, the method comprises: generating, by the processor, an auxiliary OD, the auxiliary OD being a replica of the second trained OD; and wherein the generating the plurality of domain-specific feature maps further comprises applying, by the processor, to the given training 3D point cloud from the cross-domain dataset, the feature extractor of the auxiliary OD.

In some implementations of the method, the training comprises optimizing, by the processor, a difference between the cross-domain feature map and each one of the plurality of domain-specific feature maps.

In some implementations of the method, the training the second trained OD comprises: applying, by the processor, to the cross-domain feature map a pooling operation to generate channel-wise adaptive weights; applying, by the processor, the channel-wise adaptive weights to the cross-domain feature map to generate a channel adaptive feature map; applying, by the processor, to the channel adaptive feature map, a plurality of convolutional layers to generate a plurality of adapted object-aware feature maps, each one of which corresponds to a respective domain-specific feature map of the plurality of domain-specific feature maps; and optimizing, by the processor, a difference between a given one of the plurality of adapted object-aware feature maps and the respective domain-specific feature map.

In some implementations of the method, prior to the applying the plurality of convolutional layers, the method further comprises: generating, by the processor, a heatmap of training objects in the given training 3D point cloud; applying, by the processor, to the heatmap of training objects, a convolutional layer to generate a mask of training objects in the given training 3D point cloud; and applying, by the processor, the mask of training objects to the channel adaptive feature map to highlight the training objects therein.

In some implementations of the method, the method further comprises applying, by the processor, the mask of training objects to each one of the plurality of domain-specific feature maps.

In some implementations of the method, the generating the heatmap comprises using one of the corresponding training label and the corresponding training pseudo label assigned to the given training 3D point cloud.

In some implementations of the method, the one of the corresponding training label and the corresponding training pseudo label is indicative of (i) a class of at least one training object captured by the given training 3D point cloud; and (ii) a location of the at least one training object within the given training 3D point cloud.

In some implementations of the method, the generating the heatmap comprises feeding the channel adaptive feature map to the detection head of the cross-domain OD.

In some implementations of the method, the method further comprises: generating, by the processor, a respective domain-specific heatmap for each one of the plurality of domain-specific feature maps; generating, by the processor, based on the respective heatmap, a respective domain-specific mask of training objects in the given training 3D point cloud; and the training the second trained OD further comprises optimizing, by the processor, a difference between the mask associated with the cross-domain feature map and each one of respective domain-specific masks of the plurality of domain-specific feature maps.

In some implementations of the method, the training the second trained OD comprises sampling, by the processor, training 3D point clouds and the corresponding training labels from the cross-domain dataset.

In some implementations of the method, the sampling comprises one of a uniform sampling, a random sampling, and a representative example sampling.

In some implementations of the method, the training any one of the OD, the first trained OD, and the second trained OD comprises optimizing a respective classification loss function and a respective regression loss function.

In some implementations of the method, the source domain dataset has been generated by a first LiDAR sensor; and the target domain dataset has been generated by a second LiDAR sensor, the first LiDAR sensor being different from the second LIDAR sensor.

In some implementations of the method, the source domain dataset has been generated, by a LIDAR sensor, in a first geographical location; and the target domain dataset has been generated, by the LiDAR sensor, in a second geographical location, the first geographical location being different from the second geographical location.

In some implementations of the method, the source domain dataset has been generated, by a LIDAR sensor, in a first weather condition; and the target domain dataset has been generated, by the LiDAR sensor, in a second weather condition, the first weather condition being different from the second weather condition.

In accordance with a second broad aspect of the present technology, there is provided a computer-implementable method of fine-tuning an Object Detector (OD) having been pre-trained to detect objects in 3D point clouds, in a plurality of domains. The OD comprises: (i) a feature extractor having been pre-trained to generate, based on a given 3D point cloud, a feature map; and (ii) a detection head having been pre-trained, based on the feature map, to detect the objects in the given 3D point cloud. The method is executable by a server including a processor. The method comprises: acquiring, by the processor, a given training 3D point cloud of a plurality of training 3D point clouds; feeding, by the processor, the given training 3D point could to the OD to generate a cross-domain feature map; accessing, by the processor, a plurality of domain-specific ODs, a given domain-specific OD of the plurality of domain-specific ODs having been trained to detect the objects in a respective domain of the plurality of domains; feeding, by the processor, the given training 3D point cloud to the plurality of domain-specific ODs to generate a plurality of domain-specific feature maps; optimizing, by the processor, a difference between the cross-domain feature map and each one of the plurality of domain-specific feature maps, thereby training the feature extractor of the OD to generate adapted cross-domain feature maps; and using, by the processor, the adapted cross-domain feature maps for fine-tuning the detection head of the OD to detect the objects in the plurality of domains.

In some implementations of the method, the training the feature extractor of the OD to generate the adapted cross-domain feature maps comprises: applying, by the processor, to the cross-domain feature map a pooling operation to generate channel-wise adaptive weights; applying, by the processor, the channel-wise adaptive weights to the cross-domain feature map to generate a channel adaptive feature map; applying, by the processor, to the channel adaptive feature map, a plurality of convolutional layers to generate a plurality of adapted object-aware feature maps, each one of which corresponds to a respective domain-specific feature map of the plurality of domain-specific feature maps; and optimizing, by the processor, a difference between a given one of the plurality of adapted object-aware feature maps and the respective domain-specific feature map, thereby training the OD to generate the adapted cross-domain feature maps.

In some implementations of the method, prior to the applying the plurality of convolutional layers, the method further comprises: generating, by the processor, a heatmap of training objects in the given training 3D point cloud; applying, by the processor, to the heatmap of training objects, a convolutional layer to generate a mask of training objects in the given training 3D point cloud; and applying, by the processor, the mask of training objects to the channel adaptive feature map to highlight the training objects therein.

In some implementations of the method, the generating the heatmap comprises feeding the channel adaptive feature map to the detection head of OD.

In some implementations of the method, the method further comprises: generating, by the processor, a respective domain-specific heatmap for each one of the plurality of domain-specific feature maps; generating, by the processor, based on the respective heatmap, a respective domain-specific mask of training objects in the given training 3D point cloud; and the training the feature extractor further comprises optimizing, by the processor, a difference between the mask associated with the respective cross-domain feature map and each one of respective domain-specific masks.

In some implementations of the method, the OD is a CenterPoint-based neural network.

In accordance with a third broad aspect of the present technology, there is provided a server for training an Object Detector (OD) to detect objects in 3D point clouds. The server comprises a processor and a non-transitory computer-readable medium storing instructions. The processor, upon executing the instructions, is configured to: during a first stage of a training pipeline: train the OD using a source domain dataset to detect the objects in a source domain, thereby generating a first trained OD, the source domain dataset comprising a first plurality of training 3D point clouds and corresponding training labels. Further, during a second stage of the training pipeline, the processor is configured to: train the first trained OD using a target domain dataset to detect the objects in a target domain, thereby generating a second trained OD, the target domain dataset comprising a second plurality of training 3D point clouds and the corresponding training labels. Further, during a third stage of the training pipeline, the processor is configured to: generate a cross-domain dataset using at least one 3D point cloud and the corresponding training label from the source domain dataset and at least one 3D point cloud and the corresponding training label from the target domain dataset; and train the second trained OD using the cross-domain dataset to detect objects in both the source domain and the target domain, thereby generating a cross-domain OD.

In some implementations of the server, during the first stage of the training pipeline, the processor is further configured to: acquire an other source domain dataset from an other source domain, different from the source domain; generate a combined source domain dataset including at least one training 3D point cloud from the source domain dataset and at least one training 3D point cloud from the other source domain dataset; and to generate the first trained OD the processor is configured to train the OD using the combined source domain dataset to detect the objects in each one of the source domain and the other source domain.

In some implementations of the server, during the second stage of the training pipeline, prior to the training, the processor is further configured to: acquire an unlabelled target domain dataset including a third plurality of training 3D point clouds devoid of the corresponding training labels; feed each training 3D point cloud of the unlabelled target domain dataset to the first trained OD to generate, for each training 3D point cloud of the unlabelled target domain dataset, a corresponding training pseudo label, thereby generating a pseudo-labelled target domain dataset; generate a combined target domain dataset including at least one training 3D point cloud and the corresponding training label from the target domain dataset and at least one training 3D point cloud and the corresponding training pseudo label from the pseudo-labelled target domain dataset; and wherein to generate training the second trained OD, the processor is configured to train the first trained OD using the combined target domain dataset for detecting the objects in the target domain.

In some implementations of the server, to generate the second trained OD, the processor is configured to train the first trained OD using both (i) the combined target domain dataset; and (ii) at least one training 3D point cloud data and the corresponding label from the source domain dataset to detect the objects in the target domain.

In some implementations of the server, during the first stage of the training pipeline, the processor is further configured to: acquire an other source domain dataset from an other source domain, different from the source domain; generate a combined source domain dataset including at least one training 3D point cloud from the source domain dataset and at least one training 3D point cloud from the other source domain dataset; and wherein to generate the second trained OD, the processor is configured to train the first trained OD using both (i) the combined target domain dataset; and (ii) at least one training 3D point cloud data and the corresponding label from the combined source domain dataset to detect the objects in the target domain.

In some implementations of the server, the OD comprises: (i) a feature extractor configured to generate, based on a given 3D point cloud fed thereto, a respective feature map representative of at least one object captured by the given 3D point cloud; and (ii) a detection head to be trained to detect, based on the respective feature map, the at least one object captured by the given 3D point cloud.

In some implementations of the server, the OD is a CenterPoint-based neural network.

In some implementations of the server, during the first stage of the training pipeline, the processor is further configured to: train the OD using the source domain dataset for detecting the objects in the source domain, thereby generating a trained source domain-specific OD; acquire an other source domain dataset from an other source domain, different from the source domain; train an other OD using the other source domain dataset for detecting the objects in the other source domain, thereby generating an other trained source domain-specific OD; generate a combined source domain dataset including at least one training 3D point cloud from the source domain dataset and at least one training 3D point cloud from the other source domain dataset; and wherein to generate the first trained OD, the processor is configured to train the OD using the combined source domain dataset to detect the objects in each one of the source domain and the other source domain; during the third stage of the training pipeline, prior to training, the processor is configured to: generate, for a given training 3D point cloud from the cross-domain dataset, a plurality of domain-specific feature maps by applying to the given training 3D point cloud the feature extractors of each one of the trained source domain-specific OD and the other source domain-specific OD; generate, for the given training 3D point cloud from the cross-domain dataset, a cross-domain feature map by applying, by the processor, to the given training 3D point cloud the feature extractor of the second trained OD; and wherein the processor is further configured to train the second trained OD, thereby generating the cross-domain OD, based on a comparison between the cross-domain feature map and each one of the plurality of domain-specific feature maps.

In some implementations of the server, during the third stage of the training pipeline, prior to generating the plurality of domain-specific feature maps, the processor is configured to: generate an auxiliary OD, the auxiliary OD being a replica of the second trained OD; and wherein to generate the plurality of domain-specific feature maps, the processor is further configured to apply, to the given training 3D point cloud from the cross-domain dataset, the feature extractor of the auxiliary OD.

In some implementations of the server, to train to train the second trained OD, the processor configured to optimize a difference between the cross-domain feature map and each one of the plurality of domain-specific feature maps.

In some implementations of the server, to train the second trained OD, the processor is configured to: apply, to the cross-domain feature map a pooling operation to generate channel-wise adaptive weights; apply the channel-wise adaptive weights to the cross-domain feature map to generate a channel adaptive feature map; apply, to the channel adaptive feature map, a plurality of convolutional layers to generate a plurality of adapted object-aware feature maps, each one of which corresponds to a respective domain-specific feature map of the plurality of domain-specific feature maps; and optimize a difference between a given one of the plurality of adapted object-aware feature maps and the respective domain-specific feature map.

In some implementations of the server, prior to applying the plurality of convolutional layers, the processor is further configured to: generate a heatmap of training objects in the given training 3D point cloud; apply, to the heatmap of training objects, a convolutional layer to generate a mask of training objects in the given training 3D point cloud; and apply the mask of training objects to the channel adaptive feature map to highlight the training objects therein.

In some implementations of the server, the processor is further configured to apply the mask of training objects to each one of the plurality of domain-specific feature maps.

In some implementations of the server, to generate the heatmap, the processor is configured to use one of the corresponding training label and the corresponding training pseudo label assigned to the given training 3D point cloud.

In some implementations of the server, the one of the corresponding training label and the corresponding training pseudo label is indicative of (i) a class of at least one training object captured by the given training 3D point cloud; and (ii) a location of the at least one training object within the given training 3D point cloud.

In some implementations of the server, to generate the heatmap, the processor is configured to feed the channel adaptive feature map to the detection head of the cross-domain OD.

In some implementations of the server, the processor is further configured to: generate a respective domain-specific heatmap for each one of the plurality of domain-specific feature maps; generate, based on the respective heatmap, a respective domain-specific mask of training objects in the given training 3D point cloud; and wherein to train the second trained OD further, the processor is further configured to optimize a difference between the mask associated with the cross-domain feature map and each one of respective domain-specific masks of the plurality of domain-specific feature maps.

In some implementations of the server, prior to training the second trained OD, the processor is configured to sample training 3D point clouds and the corresponding training labels from the cross-domain dataset.

In some implementations of the server, the processor is configured to sample the training 3D point clouds using one of a uniform sampling, a random sampling, and a representative example sampling.

In some implementations of the server, to train any one of the OD, the first trained OD, and the second trained OD, the processor is configured to optimize a respective classification loss function and a respective regression loss function.

In accordance with a fourth broad aspect of the present technology, thee is provided a server for fine-tuning an Object Detector (OD) having been pre-trained to detect objects in 3D point clouds, in a plurality of domains. The OD comprises: (i) a feature extractor having been pre-trained to generate, based on a given 3D point cloud, a feature map; and (ii) a detection head having been pre-trained, based on the feature map, to detect the objects in the given 3D point cloud. The server comprises a processor and a non-transitory computer-readable medium storing instructions. The processor, upon executing the instructions, is configured to: acquire a given training 3D point cloud of a plurality of training 3D point clouds; feed the given training 3D point could to the OD to generate a cross-domain feature map; access a plurality of domain-specific ODs, a given domain-specific OD of the plurality of domain-specific ODs having been trained to detect the objects in a respective domain of the plurality of domains; feed the given training 3D point cloud to the plurality of domain-specific ODs to generate a plurality of domain-specific feature maps; optimize a difference between the cross-domain feature map and each one of the plurality of domain-specific feature maps, thereby training the feature extractor of the OD to generate adapted cross-domain feature maps; and use the adapted cross-domain feature maps for fine-tuning the detection head of the OD to detect the objects in the plurality of domains.

In some implementations of the server, to train the feature extractor of the OD to generate the adapted cross-domain feature maps, the processor is configured to: apply, to the cross-domain feature map a pooling operation to generate channel-wise adaptive weights; apply the channel-wise adaptive weights to the cross-domain feature map to generate a channel adaptive feature map; apply, to the channel adaptive feature map, a plurality of convolutional layers to generate a plurality of adapted object-aware feature maps, each one of which corresponds to a respective domain-specific feature map of the plurality of domain-specific feature maps; and optimize a difference between a given one of the plurality of adapted object-aware feature maps and the respective domain-specific feature map, thereby training the OD to generate the adapted cross-domain feature maps.

In some implementations of the server, prior to applying the plurality of convolutional layers, the processor is further configured to: generate a heatmap of training objects in the given training 3D point cloud; apply, to the heatmap of training objects, a convolutional layer to generate a mask of training objects in the given training 3D point cloud; and apply the mask of training objects to the channel adaptive feature map to highlight the training objects therein.

In some implementations of the server, to generate the heatmap, the processor is configured to feed the channel adaptive feature map to the detection head of OD.

In some implementations of the server, the processor is further configured to: generate a respective domain-specific heatmap for each one of the plurality of domain-specific feature maps; generate, based on the respective heatmap, a respective domain-specific mask of training objects in the given training 3D point cloud; and wherein to train the feature extractor, the processor is further configured to optimize a difference between the mask associated with the respective cross-domain feature map and each one of respective domain-specific masks.

In some implementations of the server, the OD is a CenterPoint-based neural network.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “user device” is any computer hardware that is capable of running software appropriate to the relevant task at hand. Thus, some (non-limiting) examples of user devices include personal computers (desktops, laptops, netbooks, etc.), smartphones, and tablets, as well as network equipment such as routers, switches, and gateways. It should be noted that a device acting as a user device in the present context is not precluded from acting as a server to other user devices. The use of the expression “a user device” does not preclude multiple user devices being used in receiving/sending, carrying out or causing to be carried out any task or request, or the consequences of any task or request, or steps of any method described herein. It is contemplated that the user device and the server can be implemented as a same single entity.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context), firmware, hardware, or a combination thereof, that is both necessary and sufficient to achieve the specific function(s) being referenced.

In the context of the present specification, the expression “computer usable information storage medium” or “computer-readable medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “data domain” denotes broadly a collection of values that a data element may include in a particular setting. For example, if the data is image data, such as a 2D image or a 3D point cloud, the data domain may refer to a range of values a given pixel of the 2D image or a given point of the 3D point cloud may have, for example, in a given geographical location (such as a street, a district, a city, a country, and the like), in a given weather condition (such as cloudy, rainy, sunny, and the like), or a combination of both. In another example, the data domain may refer to a range of values the given pixel or the given point may have in a respective one of the 2D image and the 3D point cloud having been generated by a particular image sensor. In other words, in the context of the present specification, 3D point clouds generated by different LiDAR sensors are of different data domains.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of a computer system that can be used for implementing certain non-limiting embodiments of the present technology;

FIG. 2 depicts a schematic diagram of an example representation of objects captured by an imaging system of the computer system of FIG. 1 that are to be detected, in accordance with certain non-limiting embodiments of the present technology;

FIG. 3 depicts a flowchart diagram of a method for training, by a server of the computer system of FIG. 1, an Object Detector (OD) to detect the objects of FIG. 2, in accordance with certain non-limiting embodiments of the present technology;

FIGS. 4A and 4B depict various implementations of a first stage of a training pipeline of the OD to detect the objects of FIG. 2, in accordance with certain non-limiting embodiments of the present technology;

FIGS. 5A and 5B depict various implementations of a second stage of the training pipeline of the OD to detect the objects of FIG. 2, in accordance with certain non-limiting embodiments of the present technology;

FIGS. 6A and 6B depict various implementations of a third stage of the training pipeline of the OD to detect the objects of FIG. 2, in accordance with certain non-limiting embodiments of the present technology;

FIG. 7 depicts a schematic diagram of an adapting procedure for adapting cross-domain features of the OD during the third stage of the training pipeline thereof, in accordance with certain non-limiting embodiments of the present technology; and

FIG. 8 depicts a flowchart diagram of a method of fine-tuning, by the server of the computer system of FIG. 1, a pre-trained OD to detect the objects of FIG. 2.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements that, although not explicitly described or shown herein, nonetheless embody the principles of the present technology.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagram herein represents conceptual views of illustrative circuitry embodying the principles of the present technology. Similarly, it will be appreciated that any flowcharts, flow diagrams, state transition diagrams, pseudo-code, and the like represent various processes that may be substantially represented in non-transitory computer-readable media and so executed by a computer or processor, whether or not such computer or processor is explicitly shown.

The functions of the various elements shown in the figures, including any functional block labeled as a “processor” or “processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (A SIC), field programmable gate array (FPGA), read-only memory (ROM) for storing software, random access memory (RA M), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

### Computer System

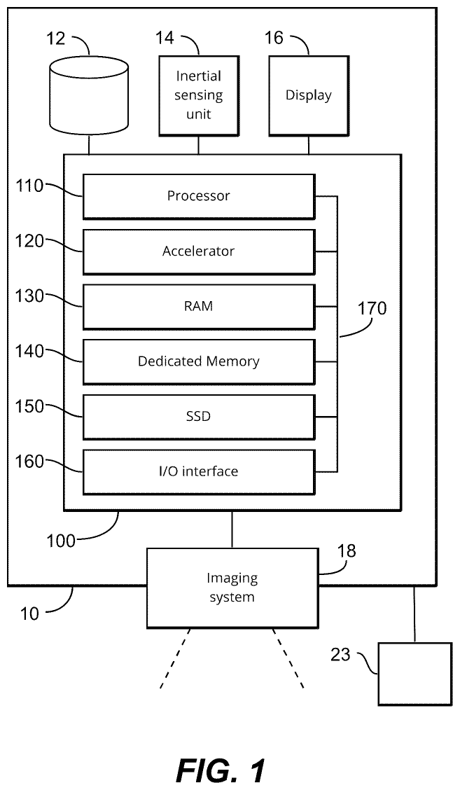

With reference to FIG. 1, there is depicted a schematic diagram of a computer system 10 configured for generating and/or processing three-dimensional (3D) point clouds in accordance with certain non-limiting embodiments of the present technology. The computer system 10 comprises a computing unit 100 that may receive captured images of an object to be detected. The computing unit 100 may be configured to generate the 3D point cloud as a representation of the object to be detected. The computing unit 100 is described in greater details hereinbelow.

In some non-limiting embodiments of the present technology, the computing unit 100 may be implemented by any of a conventional personal computer, a controller, and/or an electronic device (e.g., a server, a controller unit, a control device, a monitoring device, a personal computer, a laptop, a tablet, etc.) and/or any combination thereof appropriate to the relevant task at hand. In some non-limiting embodiments of the present technology, the computing unit 100 comprises various hardware components including one or more single or multi-core processors collectively represented by a processor 110, a solid-state drive 150, a random access memory (RAM) 130, a dedicated memory 140 and an input/output interface 160. In some non-limiting embodiments of the present technology, the computing unit 100 may be a computer specifically designed to train and/or execute a machine learning algorithm (MLA) and/or deep learning algorithms (DLA). The computing unit 100 may be a generic computer system.

In some other non-limiting embodiments of the present technology, the computing unit 100 may be an “off-the-shelf” generic computer system. In some non-limiting embodiments of the present technology, the computing unit 100 may also be distributed amongst multiple systems (such as electronic devices or servers). The computing unit 100 may also be specifically dedicated to the implementation of the present technology. Other variations as to how the computing unit 100 can be implemented are envisioned without departing from the scope of the present technology.

Communication between the various components of the computing unit 100 may be enabled by one or more internal and/or external buses 170 (e.g. a PCI bus, universal serial bus, IEEE 1394 “Firewire” bus, SCSI bus, Serial-ATA bus, ARINC bus, etc.), to which the various hardware components are electronically coupled.

The input/output interface 160 may provide networking capabilities such as wired or wireless access. As an example, the input/output interface 160 may comprise a networking interface such as, but not limited to, one or more network ports, one or more network sockets, one or more network interface controllers and the like. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to certain non-limiting embodiments of the present technology, the solid-state drive 150 stores program instructions suitable for being loaded into the RAM 130 and executed by the processor 110. Although illustrated as the solid-state drive 150, any type of memory may be used in place of the solid-state drive 150, such as a hard disk, optical disk, and/or removable storage media. According to implementations of the present technology, the solid-state drive 150 stores program instructions suitable for being loaded into the RAM 130 and executed by the processor 110 for executing generation of 3D representation of objects. For example, the program instructions may be part of a library or an application.

The processor 110 may be a general-purpose processor, such as a central processing unit (CPU) or a processor dedicated to a specific purpose, such as a digital signal processor (DSP). In some non-limiting embodiments, the processor 110 may also rely on an accelerator 120 dedicated to certain given tasks, such as executing the methods set forth in the paragraphs below. In some embodiments, the processor 110 or the accelerator 120 may be implemented as one or more field programmable gate arrays (FPGAs). Moreover, explicit use of the term “processor”, should not be construed to refer exclusively to hardware capable of executing software, and may implicitly include, without limitation, application specific integrated circuit (A SIC), read-only memory (ROM) for storing software, RAM, and non-volatile storage. Other hardware, conventional and/or custom, may also be included.

Further, in certain non-limiting embodiments of the present technology, the computer system 10 comprises an imaging system 18 that may be configured to capture Red-Green-Blue (RGB) images or a series thereof. The imaging system 18 may comprise camera sensors such as, but not limited to, Charge-Coupled Device (CCD) or Complementary Metal Oxide Semiconductor (CM OS) sensors and/or digital cameras.

Further, according to certain non-limiting embodiments of the present technology, the imaging system 18 may be configured to convert an optical image into an electronic or digital image and may send captured images to the computing unit 100. In some non-limiting embodiments of the present technology, the imaging system 18 may be a single-lens camera providing RGB pictures. In these embodiments, the imaging system 18 can be implemented as a camera of a type available from FLIR INTEGRATED IMAGING SOLUTIONS INC., 12051 Riverside Way, Richmond, BC, V6 W 1K 7, Canada. It should be expressly understood that the single-lens camera can be implemented in any other suitable equipment.

Further, in other non-limiting embodiments of the present technology, the imaging system 18 comprises depth sensors configured to acquire RGB-Depth (RGBD) pictures. In yet other non-limiting embodiments of the present technology, the imaging system 18 can include a LIDAR system configured for gathering information about surroundings of the computer system 10 or another system and/or object to which the computer system 10 is coupled. It is expected that a person skilled in the art would understand the functionality of the LIDAR system, but briefly speaking, a light source of the LiDAR system is configured to send out light beams that, after having reflected off one or more surrounding objects in the surroundings of the computer system 10, are scattered back to a receiver of the LiDAR system. The photons that come back to the receiver are collected with a telescope and counted as a function of time. Using the speed of light (˜3×108 m/s), the processor 110 of the computing unit 100 of the computer system 10 can then calculate how far the photons have traveled (in the round trip). Photons can be scattered back off of many different entities surrounding the computer system 10.

In a specific non-limiting example, the LiDAR system can be implemented as the LIDAR based sensor that may be of the type available from VELODYNE LIDAR, INC. of 5521 Hellyer Avenue, San Jose, CA 95138, United States of America. It should be expressly understood that the LiDAR system can be implemented in any other suitable equipment.

Other implementations of the imaging system 18 enabling generating 3D point clouds, including, for example, depth sensors, 3D scanners, and other suitable devices are envisioned without departing from the scope of the present technology.

Thus, by using one of the approaches non-exhaustively described above, the imaging system 18 can be configured to generate 3D point clouds of surrounding objects of the computer system 10. For example, in those embodiments where the computer system 10 is utilized outdoors, such objects can include, without limitation, particles (aerosols or molecules) of water, dust, or smoke in the atmosphere, moving and stationary surrounding objects of various object classes. In this example, object classes of the moving surrounding objects can include, without limitation, vehicles, trains, cyclists, pedestrians or animals. By contrast, object classes of the stationary objects can include, without limitation, trees, fire hydrants, road posts, streetlamps, traffic lights, and the like.

In another example, where the computer system 10 is utilized indoors, such as in a given room, the surrounding objects can include, without limitation, walls of the given room, furniture articles disposed therein, electric and electronic devices installed or used in the given room (such as home appliances, for example), people, pets, and the like.

In some non-limiting embodiments of the present technology, the imaging system 18 of the computer system 10 can be implemented as an external imaging system (not depicted) configured to: (i) be coupled to the computer system 10 via a respective input/output external interface, such as, a Universal Serial Bus™ (USB) and various configurations thereof, as an example, or any other input/output interface non-exhaustively listed above, as an example; and (ii) transmit captured data to the computing unit 100.

Further, in some non-limiting embodiments of the present technology, the computer system 10 may comprise an Inertial Sensing Unit (ISU) 14 configured to be used in part by the computing unit 100 to determine a position of the imaging system 18 and/or the computer system 10. Therefore, the computing unit 100 may determine a set of coordinates describing the location of the imaging system 18, and thereby the location of the computer system 10, in a coordinate system based on the output of the ISU 14. Generation of the coordinate system is described hereinafter. The ISU 14 may comprise 3-axis accelerometer(s), 3-axis gyroscope(s), and/or magnetometer(s) and may provide velocity, orientation, and/or other position related information to the computing unit 100.

Further, in some non-limiting embodiments of the present technology, the computer system 10 may include a screen or display 16 capable of rendering color 2D and/or 3D images captured by the imaging system 18. In some non-limiting embodiments of the present technology, the display 16 may be used to display live images captured by the imaging system 18, 3D point clouds, Augmented Reality (AR) images, Graphical User Interfaces (GUIs), program output, etc. In some embodiments, display 16 may comprise and/or be housed with a touchscreen to permit users to input data via some combination of virtual keyboards, icons, menus, or other Graphical User Interfaces (GUIs). In some non-limiting embodiments of the present technology, display 16 may be implemented using a Liquid Crystal Display (LCD) display or a Light Emitting Diode (LED) display, such as an Organic LED (OLED) display. In other embodiments, display 16 may be remotely communicatively connected to the computer system 10 via a wired or a wireless connection (not shown), so that outputs of the computing unit 100 may be displayed at a location different from the location of the computer system 10. In this situation, the display 16 may be operationally coupled to, but housed separately from, other functional units and systems in computer system 10. The computer system 10 may be, for example, an iPhone or mobile phone from Apple or a Galaxy mobile phone or tablet from Samsung, or any other mobile device whose features are similar or equivalent to the aforementioned features. The device may be, for example and without being limitative, a handheld computer, a personal digital assistant, a cellular phone, a network device, a camera, a smart phone, an enhanced general packet radio service (EGPRS) mobile phone, a network base station, a media player, a navigation device, an e-mail device, a game console, or a combination of two or more of these data processing devices or other data processing devices.

According to certain non-limiting embodiments of the present technology, the computer system 10 may comprise a memory 12 communicatively connected to the computing unit 100 and configured to store without limitation data, captured images, depth values, sets of coordinates of the computer system 10, 3D point clouds, and raw data provided by ISU 14 and/or the imaging system 18. The memory 12 may be embedded in the computer system 10. The computing unit 100 may be configured to access a content of the memory 12 via a network (not shown) such as a Local Area Network (LAN) and/or a wireless connexion such as a Wireless Local Area Network (WLAN).

The computer system 10 may also include a power system (not depicted) for powering its components. The power system may include a power management system, one or more power sources (e.g., battery, alternating current (AC)), a recharging system, a power failure detection circuit, a power converter or inverter and any other components associated with the generation, management and distribution of power in mobile or non-mobile devices.

As such, in at least some embodiments of the present technology, the computer system 10 may also be suitable for generating the 3D point cloud of a given object directly or based on 2D or 3D images thereof. Such images may have been captured by the imaging system 18, as described in detail above. As an example, the computer system 10 may generate the 3D point cloud according to the teachings of the Patent Cooperation Treaty Patent Publication No. 2020/240497, an entirety of the contents which is hereby incorporated by reference.

Summarily, it is contemplated that the computer system 10 may perform at least some of the operations and steps of methods described in the present disclosure. More specifically, the computer system 10 may be suitable for generating 3D point clouds of various objects (such as those mentioned above) including data points representative thereof. For example, in some non-limiting embodiments of the present technology, the computer system 10 can be part of a control system of an autonomous vehicle (also known as a “self-driving car”, not depicted) and generate the 3D point clouds representative of surrounding objects of the autonomous vehicle. In these embodiments, based on the data of the surrounding objects determined via the 3D point clouds, the processor 110 of the computer system 10 can be configured, for example, to generate a trajectory for the autonomous vehicle. In another example, based on the data of the surrounding objects, the processor 110 can be configured to generate (or otherwise validate) a 3D map for navigation of the autonomous vehicle.

Further, according to certain non-limiting embodiments of the present technology, the computer system 10 can be communicatively connected (e.g. via any wired or wireless communication link including, for example, 4G, LTE, Wi-Fi, or any other suitable connection) to a server 23.

In some embodiments of the present technology, the server 23 is implemented as a computer server and could thus include some or all of the components of the computing unit 100 of FIG. 1. In one non-limiting example, the server 23 is implemented as a Dell™ PowerEdge™ Server running the Microsoft™ Windows Server™ operating system, but can also be implemented in any other suitable hardware, software, and/or firmware, or a combination thereof. In some non-limiting embodiments of the present technology, the server 23 can be a single server. In alternative non-limiting embodiments of the present technology, the functionality of the server 23 may be distributed and may be implemented via multiple servers.

The server 23 can be configured to execute some or all of the steps of the present methods. More specifically, according to certain non-limiting embodiments of the present technology, the server 23 can be configured to: (i) acquire, from the computer system 10, a given 3D point cloud; and (ii) based on the given 3D point cloud, detect the objects captured therein.

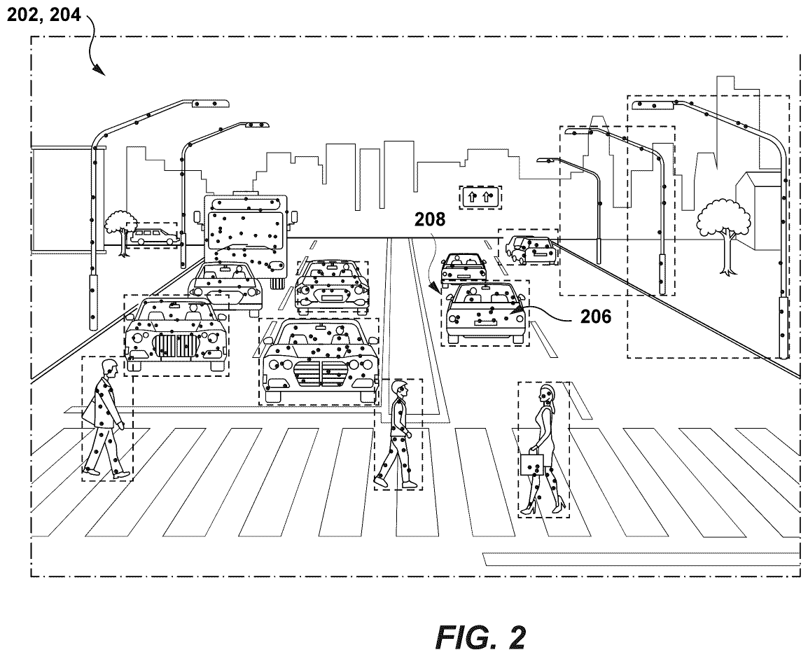

With reference to FIG. 2, there is depicted a schematic diagram of a representation of a given road section 202 as perceived from a point of view of the imaging device 18 when the computer system 10 is used as part of the control system of the autonomous vehicle, in accordance with certain non-limiting embodiments of the present technology.

As it can be appreciated from FIG. 2, the processor 110 of the computer system 10 can be configured to generate a given 3D point cloud 204 including data points representative of objects in the given road section 202, such as a given surrounding object 206. Generally speaking, a given data point is a point in 3D space indicative of at least a portion of a surface of the given surrounding object 206 in the given road section 202 that has been captured by the imaging system 18 of the computer system 10.

Further, as mentioned above, the server 23 can be configured to receive the given 3D point cloud 204 from the computer system 10 and detect the given surrounding object 206 therein. In other words, the server 23 can be configured: (i) to localize the given surrounding object 206 in a coordinate system associated, for example, with the imaging system 18 or the autonomous vehicle (not depicted); and (ii) determine a respective object class of the given surrounding object 206, that is, a vehicle. More specifically, according to certain non-limiting embodiments of the present technology, the server 23 can be configured to localize the given surrounding object 206 in the given 3D point cloud 204 by generating, around the given surrounding object 206, a respective bounding box 208; and based on features of data points of the given 3D point cloud 204 within the respective bounding box 208, determine the respective object class of the given surrounding object 206.

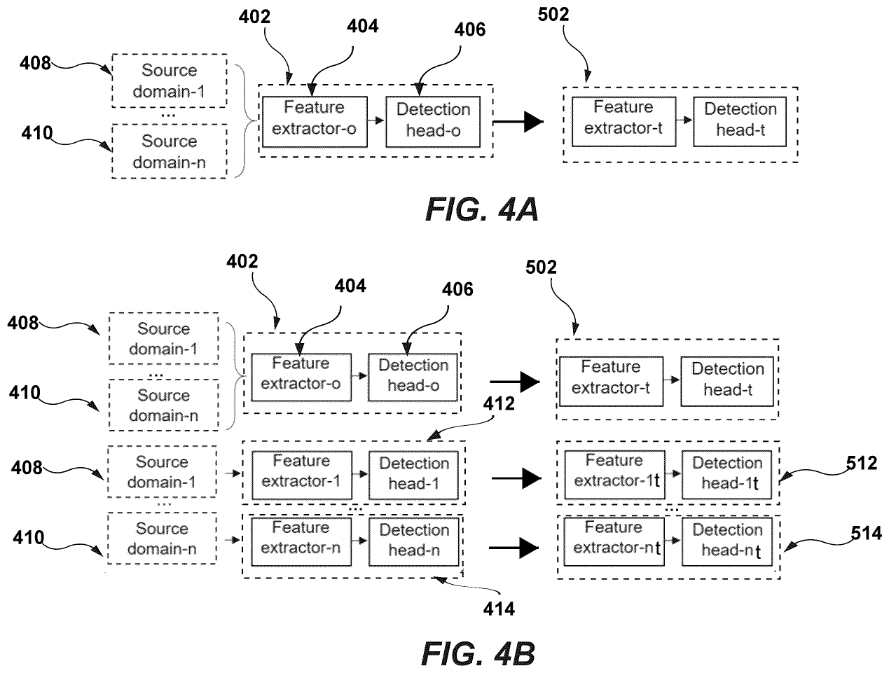

According to certain non-limiting embodiments of the present technology, to detect the given surrounding object 206 in the given 3D point cloud 204, the server 23 can be configured to train and further execute an object detection machine-learning model (also referred to herein as an “object detector” or simply “OD”, for short), such as an OD 402, schematically depicted in FIG. 4.

Broadly speaking, according to certain non-limiting embodiments of the present technology, the OD 402 can comprise (i) a feature extractor 404 configured to determine feature maps (or otherwise “feature vectors”) including latent features that are representative of the objects captured in the given 3D point cloud 204; and (ii) a detection head 406 configured to identify the objects based on the feature maps generated by the feature extractor 404. In some non-limiting embodiments of the present technology, the feature extractor 404 can be implemented based on a convolutional neural network configured to determine latent features of the 3D point clouds input therein. Non-limiting examples of an architecture for implementing the features extractor 404 can include at least one of: Voxel ResNet, Point ResNet, PointNet, and UNet.

In the interim, according to certain non-limiting embodiments of the present technology, the detection head 406 of the OD 402 can include a heatmap head (not depicted) configured to determine centers of the bounding boxes associated with the objects; and a dimension head (also not depicted) configured to determine dimensions of a given bounding box, such as those of the respective bounding box 208, based on which the detection head 406 can be configured to further determine the respective object class of the given surrounding object 206. For example, in those embodiments where the feature extractor 404 is implemented based on the convolutional neural network, the detection head 406 can comprise outer convolutional layers of the convolutional neural network, configured to process the feature maps generated by the feature extractor 404 to detect the objects in the given 3D point cloud 204.

In a specific non-limiting example, the OD 402 can be a CenterPoint-based neural network implemented as described, for example, in an article “OBJECTS AS POINTS”, authored by Zhou et al., the content of which is incorporated herein by reference in its entirety. However, it should be expressly understood that other object detection frameworks can also be used for implementing the OD 402 without departing from the scope of the present technology, including, without limitation, a PointPillars framework, a VoxelNet framework, a Point-Voxel Region-based Convolutional Neural Network (PV-RCNN), and a PillarNet framework, for example.

Generally speaking, to train the OD 402 to detect the objects in the given 3D point cloud 204, the server 23 can be configured to (i) acquire a training dataset including a plurality of training 3D point clouds, each of which has a corresponding label including a respective location and a respective object class of at least one training object captured by a given training 3D point cloud; (ii) feed each one of the plurality of training 3D point clouds to the OD 402; and (iii) optimize a difference between predictions of the OD 402 on each training 3D point cloud and the corresponding label associated therewith, using a backpropagation algorithm, thereby adjusting inner parameters (such as node weights of a neural network) of the OD 402. In some non-limiting embodiments of the present technology, a difference between the predictions of the OD 402 and the corresponding labels can be expressed by a loss function, comprising: (i) a regression loss function for training the OD 402 to localize the objects within the given 3D point cloud 204; and (ii) a classification loss function for training the OD 402 to determining the object classes of the objects.

However, the developers of the present technology have realized that such an approach to training the OD 402 can have certain drawbacks. More specifically, the developers have realized that to train the OD 402 for detecting objects in 3D point clouds of multiple domains (such as those generated in different cities or by different configurations of the imaging system 18, as an example) may require generating, for each of the domains, a separate training dataset of labelled training 3D point clouds, which may be costly and inefficient.

Thus, the non-limiting embodiments of the present technology are directed to a specific training pipeline of the OD 402 for detecting objects, using training datasets of a plurality of domains and transferring knowledge of training objects, such as feature maps indicative thereof, across the plurality of domains. By doing so, the present methods and systems may help reduce the use of the labelled training data and increase the overall accuracy of the object detection.

More specifically, as will be described in greater detail below, in accordance with certain non-limiting embodiments of the present technology, the training pipeline of the OD 402 includes three stages, where: (i) during a first stage, the server 23 is configured to train the OD 402 to detect the object in at least one source domain; (ii) during a second stage, the server 23 is configured to train the OD 402 to detect the objects in a target domain, different from the at least one source domain; and (iii) during a third stage, the server 23 is configured to train the OD 402 to detect the objects in both the at least one source domain and the target domain. In other words, the present method and systems are directed to a multi-stage training pipeline of the OD 402, where: during the first stage, the OD 402 is pre-trained to detect the objects in the at least one source domain; during the second stage, the OD 402 is fine-tuned to detect the objects in the target domain; and during the third stage, the OD 402 is fine-tuned again to detect the object both in the at least one source and the target domain.

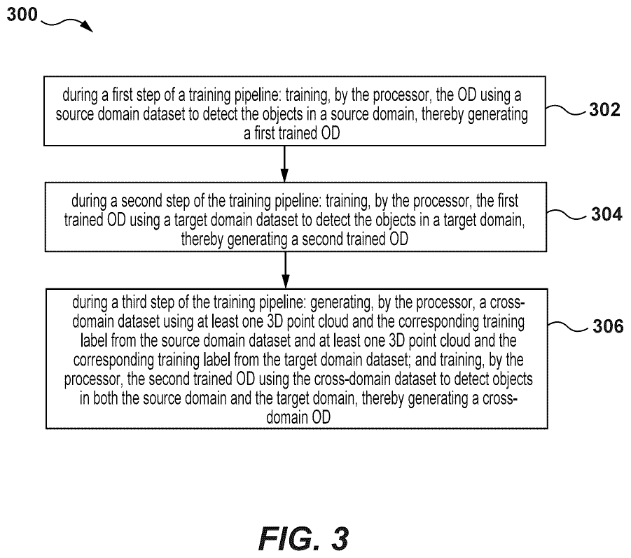

With reference to FIG. 3, there is depicted a flowchart diagram of a method 300 for training the OD 402 to detect objects in the 3D point clouds, such as the given surrounding object 206 in the given 3D point cloud 204, in accordance with certain non-limiting embodiments of the present technology. According to certain non-limiting embodiments of the present technology, the method 300 can be executed by a processor of the server 23.

### Step 302: During a First Stage of a Training Pipeline: Training, by the Processor, the OD Using a Source Domain Dataset to Detect the Objects in a Source Domain, Thereby Generating a First Trained OD

The method 300 commences at step 302 with the server 23 being configured to execute the first stage of the training pipeline introduced above-train the OD 402 to detect the objects in the 3D point cloud of the at least one source domain.

With reference to FIG. 4A, there is depicted a schematic diagram of the first stage of the training pipeline of training the OD 402, in accordance with certain non-limiting embodiments of the present technology.

According to certain non-limiting embodiments of the present technology, the server 23 can be configured to train the OD 402 to detect the objects in the 3D point clouds of a given source domain based on a given source domain dataset 408. According to certain non-limiting embodiments of the present technology, the given source domain dataset 408 can include: (i) a first plurality of training 3D point clouds; (ii) and corresponding labels, indicative of a respective location and a respective object class of at least one training object in each one of the first plurality of training 3D point clouds.

According to certain non-limiting embodiments of the present technology, each one of the first plurality of training 3D point clouds can be generated by the imaging system 18 of the computer system 10, as described above with respect to the given 3D point cloud 204. Further, the computer system 10 can be configured to either store each one of the first plurality of training 3D point clouds in one of the RAM 130, dedicated memory 140, and the SSD 15, prior to transmitting each one of the first plurality of training 3D point clouds to the server 23; or transmit each one of the first plurality of training 3D point clouds to the server 23 directly, without preliminarily storing them.

Further, according to certain non-limiting embodiments of the present technology, after receiving the first plurality of training 3D point clouds, the server 23 can be configured to transmit the first plurality of training 3D point clouds for labelling, for example, to a server (not depicted) of an online crowdsourcing platform, such as an Amazon™ Mechanical Turk™ online crowdsourcing platform, and the like, with a respective labelling task. For example, the respective labelling task can comprise to indicate locations of training objects in each one of the first plurality of training 3D point clouds, such as by a respective bounding box, and determine the respective object class of each training object. In response, the server of the online crowdsourcing platform can be configured to distribute the first plurality of training 3D point clouds among human assessors along with the respective labelling task. Once each one of the first plurality of training 3D point clouds has been labelled by the human assessors, the server of the online crowdsourcing platform can be configured to transmit the so labelled first plurality of training 3D point clouds back to the server 23 for training the OD 402. However, it should be noted that, in other non-limiting embodiments of the present technology, the server 23 can be configured to receive the first plurality of training 3D point clouds that has already been labelled from any other third-party server (not depicted) without departing from the scope of the present technology.

Further, according to certain non-limiting embodiments of the present technology, each one of the first plurality of training 3D point clouds is of the given source domain. In other words, according to certain non-limiting embodiments of the present technology, each one of the first plurality of training 3D point clouds can be generated given at least one of: (i) a given geographical location; (ii) a given weather condition; and (iii) a given configuration of the imaging system 18. According to certain non-limiting embodiments of the present technology, the given geographical location broadly denotes an area of finite dimensions defined either (i) by administrative division in a given country, such as a block of a street, a district, a borough, a city, a region, such as a state or a province, and the like; or (ii) geometrically, such as using a given shape, including, for example, a circle or a square, and the like, of predetermined dimensions, such as 100 m by 100 m, 10 km by 10 km, and the like. Further, according to certain non-limiting embodiments of the present technology, the given weather condition can include at least one of: a sunny weather, a cloudy weather, a rainy weather, a windy weather, a snowy weather, and the like.

Further, a given configuration of the imaging system 18 can be defined by certain values of inherent parameters of the imaging system 18. For example, in those non-limiting embodiments where the imaging system 18 is a LIDAR system, such parameters can include, without limitation, a field of view, a data point density, and a sidelap of the LiDAR system. Thus, for example, a given training 3D point cloud generated by a LiDAR system configured to emit 32 laser beams is of a different domain from that generated by another LiDAR system configured to stir 64 laser beams to the surrounding area of the computer system 10.

Thus, to train the OD 402 to detect the objects in the given source domain, the server 23 can be configured to (i) feed, to the OD 402, the given source domain dataset 408; and (ii) iteratively optimize, for each one of the first plurality of training 3D point clouds, a difference between predictions of the detection head 406 of the OD 402 and the corresponding label associated with each one of the first plurality of training 3D point clouds. As noted hereinabove, the difference can be expressed by the regression loss function and the classification loss function, by optimizing values of which, the server 23 can be configured to train the OD 402 to determine the locations and object classes of the objects in the given source domain.

According to certain non-limiting embodiments of the present technology, the regression loss function can be an L1 regression loss function, which is expressed by a following equation:

$${ℒ}_{reg} = \vert y - \hat{y} \vert , \qquad ( 1 )$$

where y is a prediction of the OD 402 with respect to a respective location of the at least one training object in the given training 3D point cloud; and
   ŷ is a ground truth defined by the corresponding label associated with the given training 3D point cloud.

Further, according to certain non-limiting embodiments of the present technology, the classification loss function can be a focal loss function, expressed by a following equation:

$${ℒ}_{cls} = \sum \{ \begin{matrix}{( 1 - y )}^{2} log ( y ) & if \hat{y} = 1 \\ {( 1 - \hat{y} )}^{4} {( y )}^{2} log ( 1 - y ) & otherwise\end{matrix} , \qquad ( 2 )$$

where y is a prediction of the OD 402 with respect to a respective object class of the at least one training object in the given training 3D point cloud; and
   ŷ is the ground truth defined by the corresponding label associated with the given training 3D point cloud.

Also, in some non-limiting embodiments of the present technology, the server 23 can be configured to train the OD 402 to detect the objects in a plurality of source domains. More specifically, in these embodiments, the server 23 can be configured to: (1) acquire at least one other source domain dataset 410 of a plurality of other source domains; (2) generate, based on the given source domain dataset 408 and the at least one other source domain dataset 410, a combined source domain dataset; and (3) use the combined source domain dataset for training the OD 402 to detect objects in the plurality of source domain in a similar manner as described above. Akin to the given source domain dataset 408, each other source domain dataset of the at least one other source domain dataset 410 includes: (i) a respective plurality of training 3D point clouds of a respective other source domain that is different from the given source domain; and (ii) the corresponding labels associated with each one of the respective plurality of training 3D point clouds. For example, a given training point cloud of the at least one other source domain dataset 410 and a given raining 3D point cloud of the given source domain dataset can be generated in different geographical locations, such as in different cities. In another example, the given training point cloud of the at least one other source domain dataset 410 and the given raining 3D point cloud of the given source domain dataset can be generated in different weather conditions, such as in cloudy and sunny weather, respectively. In yet other example, the given training point cloud of the at least one other source domain dataset 410 and the given raining 3D point cloud of the given source domain dataset can be generated by different configurations of the imagining system 18, such as by a 32-beam and 64-beam LiDAR system, respectively. Needless to state, each other source domain dataset of the at least one other source domain dataset 410 can be generated and labelled similarly to the given source domain dataset 408, as described above.

Thus, by doing so, in some non-limiting embodiments of the present technology, the server 23 can be configured to generate a first trained OD 502.

Also, as will become apparent from the description provided hereinbelow, in some non-limiting embodiments of the present technology, during the first stage of the training pipeline, the server 23 can further be configured to train a plurality of source domain-specific ODs. With reference to FIG. 4B, there is depicted a schematic diagram of the first stage of the training pipeline of the OD 402, in accordance with certain other non-limiting embodiments of the present technology.

More specifically, according to certain non-limiting embodiments of the present technology, during the first stage of the training pipeline, aside from training the OD 402 to detect the objects in the at least one source domain, thereby generating the first trained OD 502, the server 23 can be configured to train a first replica 412 and at least one other replica 414 of the OD 402 to detect the objects in respective source domains. More specifically, the server 23 can be configured to train, based on the given source domain data set 408, the first replica 412 to detect the objects in the given source domain, thereby generating a given source domain-specific OD 512. Similarly, the server 23 can be configured to train the at least one other replica 414 of the OD 402 based on a respective other source domain of the at least one other source domain dataset 410 to detect objects in a respective other source domain of the at least one source domain, thereby generating at least one other source domain-specific OD 514.

The method 300 hence advances to step 304.

### Step 304: During a Second Stage of the Training Pipeline: Training, by the Processor, the First Trained OD Using a Target Domain Dataset to Detect the Objects in a Target Domain, Thereby Generating a Second Trained OD

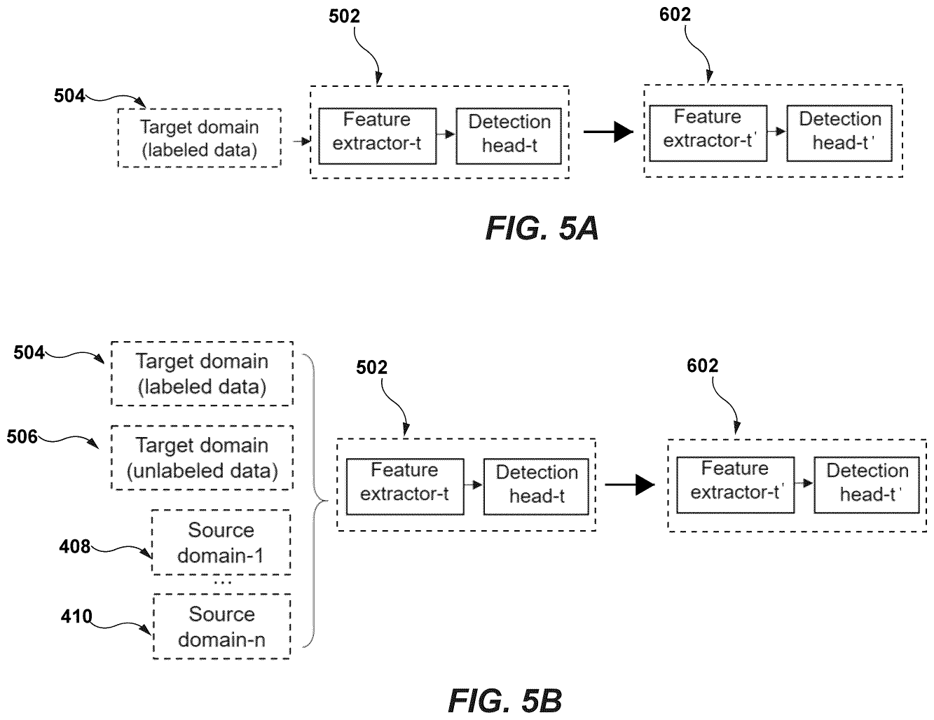

At step 304, according to certain non-limiting embodiments of the present technology, the server 23 can be configured to execute the second stage of the training pipeline of the OD 402, a schematic diagram of which is depicted, in accordance with certain non-limiting embodiments of the present technology, in FIG. 5A.

More specifically, in some non-limiting embodiments of the present technology, during the second stage of the training pipeline, the server 23 can be configured to: (i) acquire a target domain dataset 504 including a second plurality of training 3D point clouds of a target domain; and (ii) using the target domain dataset 504, train the first trained OD 502 to detect the objects in the target domain. According to certain non-limiting embodiments of the present technology, the target domain can be different from any one of the given source domain and the at least one other source domain. In other words, as explained hereinabove, each training 3D point cloud of the target domain dataset 504 and the given training 3D point cloud of one of the given source domain dataset 408 and the at least one other source domain dataset 410 have been generated either (i) in different geographical locations; or (ii) in different weather conditions; or (iii) by different configurations of the imaging system 18, as an example. Also, in some non-limiting embodiments of the present technology, different combination of the conditions (i), (ii), and (iii) can apply for generating each training 3D point cloud of the target domain dataset 504.

According to certain non-limiting embodiments of the present technology, the target domain dataset 504 can have a similar structure to that, for example, of the given source domain dataset 408, that is, including the second plurality of training 3D point clouds, each of which has been preliminarily assigned with the corresponding label indicative of the respective location and respective object class of at least one training object in a given training 3D point cloud of the second plurality of training 3D point clouds. The corresponding labels may have been assigned to each one of the second plurality of training 3D point clouds similarly to assigning the corresponding labels to each training 3D point clouds of the first plurality of training 3D point clouds, as described above. However, in some non-limiting embodiments of the present technology, the target domain dataset 504 can differ from the given source domain dataset 408 in size. In other words, in some non-limiting embodiments of the present technology, the target domain dataset 504 can include fewer members, that is, the training 3D point clouds and the corresponding labels thereof, than the given source domain dataset 408.

Thus, by feeding the target domain dataset 504 to the first trained OD 502, optimizing the regression and classification loss functions as mentioned above, the server 23 can be configured to generate a second trained OD 602 configured to detect the objects in the target domain.

However, in some non-limiting embodiments of the present technology, the server 23 can be configured to generate the second trained OD 602 differently. With reference to FIG. 5B, there is depicted a schematic diagram of the second stage of the training pipeline of the OD 402, in accordance with certain other non-limiting embodiments of the present technology.

More specifically, according to certain non-limiting embodiments of the present technology, the server 23 can be configured to: (i) acquire, such as from the computer system 10, an unlabelled target domain dataset 506 including a third plurality of training 3D point clouds, each one of which is devoid of the corresponding label; (ii) generate, for each one of the third plurality of training 3D point clouds, a corresponding pseudo label, thereby generating a pseudo-labelled target domain dataset (not depicted); (iii) generate a combined target domain dataset including at least one training 3D point cloud and the corresponding label from the target domain dataset 504 and at least one training 3D point cloud and the corresponding pseudo label from the pseudo-labelled target domain dataset; and (iv) train the first trained OD 502 using the combined target domain dataset to detect the objects in the target domain, thereby generating the second trained OD 602.

Broadly speaking, the corresponding pseudo label, akin to the corresponding label generated by a human assessor, is indicative of the respective location and object class of the at least one training object in a given training 3D point cloud of the third plurality of training 3D point clouds, however, generated by the server 23 automatically. For example, in some non-limiting embodiments of the present technology, the server 23 can be configured to generate the corresponding pseudo label for the given training 3D point cloud by applying thereto the first trained OD 502, generated during the first stage of the training pipeline. By doing so, fewer human-labelled training 3D point clouds can be required for training the first trained OD for detecting objects in the target domain, which may thus increase efficiency of the training pipeline.

Further, similar to training the first trained OD 502 based only on the target domain dataset 504, in some non-limiting embodiments of the present technology, the server 23 can be configured to train the first trained OD 502 to detect the objects in the target domain using the combined target domain dataset including both human-labelled and pseudo-labelled training 3D point clouds optimizing the regression and classification loss functions, thereby generating the second trained OD 602. However, it should be noted that, in some non-limiting embodiments of the present technology, the server 23 can be configured to train the first trained OD 502 using only the pseudo-labelled target domain dataset.

Further, along with training 3D point clouds of at least one of the target domain dataset 504 and the pseudo-labelled target domain dataset, in some non-limiting embodiments of the present technology, to train the first trained OD 502 to detect the objects in the target domain, thereby generating the second trained OD 602, the server 23 can be configured to use training point clouds from one of the plurality of source domains mentioned above. For example, in some non-limiting embodiments of the present technology, to train the first trained OD 502 to detect the objects in the target domain, the server 23 can be configured to use, along with the combined target domain target dataset, at least one training 3D point cloud and the corresponding label of the given source domain dataset 408. However, in another example, to generate the second trained OD 602, along with the combined target domain dataset, the server 23 can be configured to use training 3D point clouds and the corresponding labels thereof from the combined source domain dataset, including the at least one other source domain dataset 410.

The method 300 hence advances to step 306.

Step 306: During a Third Stage of the Training Pipeline: Generating, by the Processor, a Cross-Domain Dataset Using at Least One 3D Point Cloud and the Corresponding Training Label from the Source Domain Dataset and at Least One 3D Point Cloud and the Corresponding Training Label from the Target Domain Dataset; and Training, by the Processor, the Second Trained OD Using the Cross-Domain Dataset to Detect Objects in Both the Source Domain and the Target Domain, Thereby Generating a Cross-Domain OD

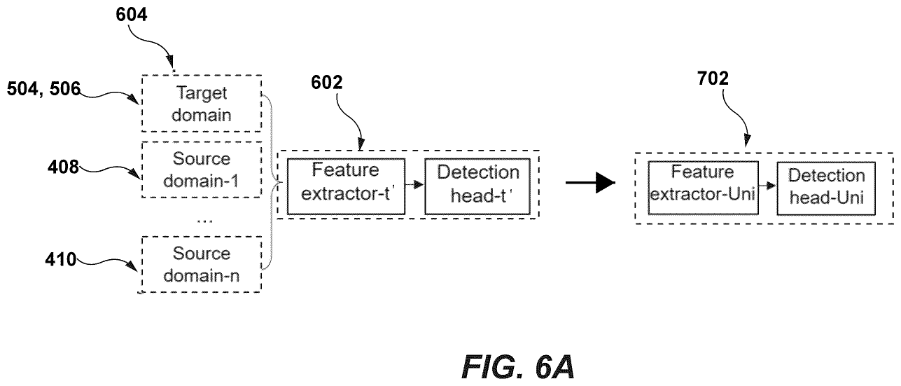

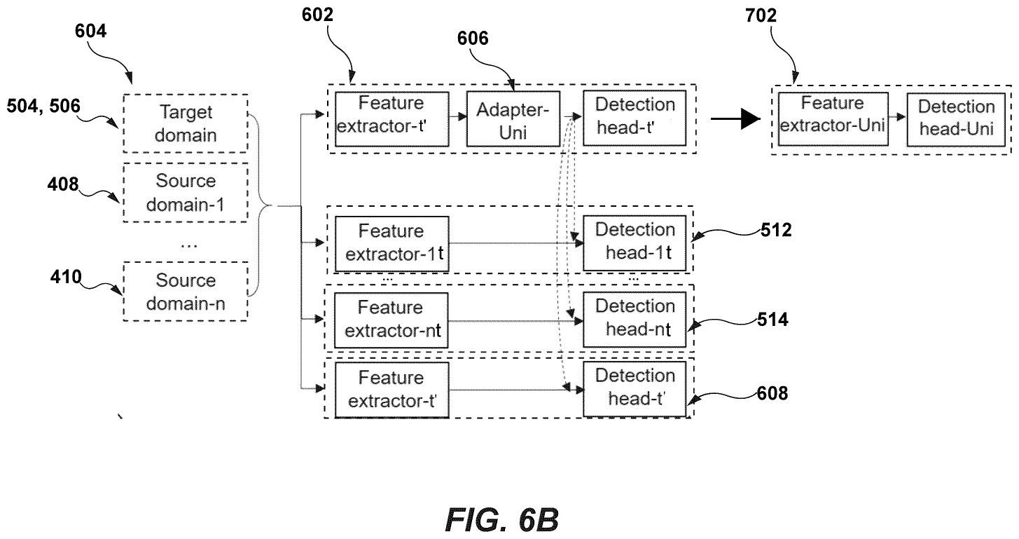

At step 306, the server 23 can be configured to execute the third stage of the training pipeline of the OD 402, a schematic diagram of which is depicted, in accordance with certain non-limiting embodiments of the present technology, in FIG. 6A.

More specifically, as mentioned hereinabove during the third stage of the training pipeline, the server 23 is configured to train the second trained OD 602 to detect the object both in the at least one source domain and the target domain, thereby generating a cross-domain OD 702. To that end, the server 23 can be configured to: (1) generate a cross-domain dataset 604; and, similarly, (2) feed the cross-domain dataset 604 to the second trained OD 602 optimizing the regression and classification loss functions, thereby generating the cross-domain OD 702.

According to certain non-limiting embodiments of the present technology, the cross-domain dataset 604 can include at least: (i) at least one training 3D point cloud and the corresponding label of the given source domain dataset 408; and (ii) at least one training 3D point cloud and the corresponding label of the target domain dataset 504. However, in other non-limiting embodiments of the present technology, the cross-domain dataset 604 can further include (iii) at least one training 3D point cloud and the corresponding label thereof from the at least one other source domain dataset 410. In yet other non-limiting embodiments of the present technology, the cross-domain dataset 604 can further include (iv) at least one training 3D point cloud and the corresponding pseudo label from pseudo-labelled target domain dataset, generated based on the unlabelled target domain dataset 506 as described above.

By doing so, the server 23 can be configured to generate the cross-domain dataset 604 for training the second trained OD 602 to detect the objects in both the at least one source domain and the target domain, thereby generating the cross-domain OD 702.

However, according to certain non-limiting embodiments of the present technology, the server 23 can be configured to train the second trained OD 602 differently. With reference to FIG. 6B, there is depicted a schematic diagram of the third stage of the training pipeline of the OD 402, in accordance with certain other non-limiting embodiments of the present technology.

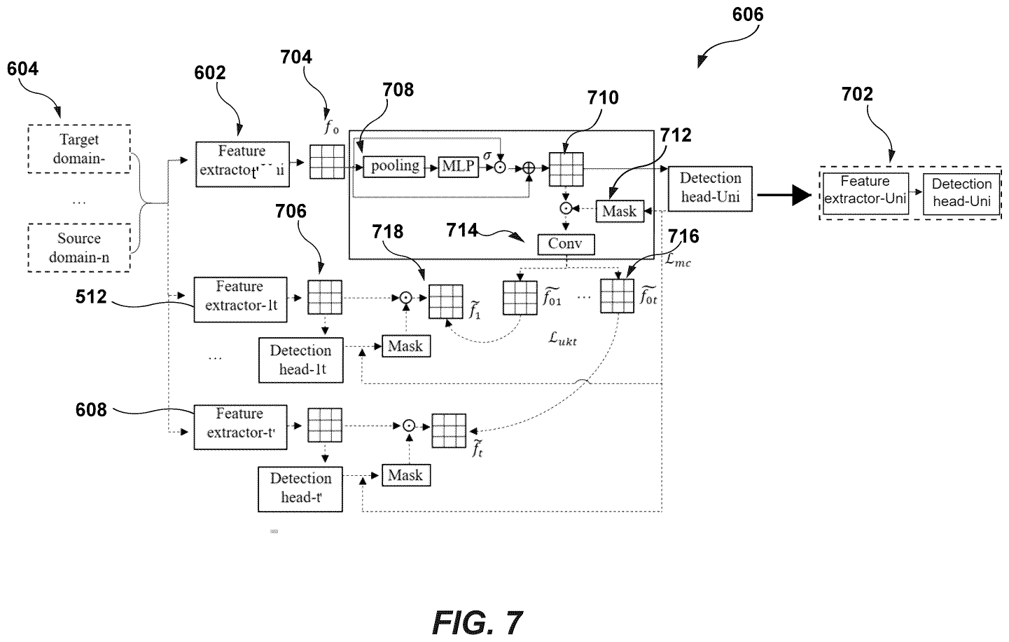

In some non-limiting embodiments of the present technology, while training the second trained OD 602 based on the cross-domain dataset 604, the server 23 can be configured to adapt cross-domain feature maps (such as a respective cross-domain feature map 704 as depicted in FIG. 7) generated by the feature extractor (not separately labelled) of the second trained OD 602 to domain-specific feature maps (such as a respective plurality of domain-specific feature maps 706 as depicted in FIG. 7) generated by feature extractors (not separately labelled) of source domain-specific ODs, such as the given source domain-specific OD 512 and the at least one other source-domain specific OD 514, trained as described above with respect to certain embodiments of the first stage of the training pipeline. In other words, in these embodiments, aside from optimizing the regression and classification loss functions when training the second trained OD 602, the server 23 can further be configured to optimize a difference between the cross-domain feature maps and the domain-specific feature maps.

More specifically, in these embodiments, the server 23 can be configured to: (1) feed a given training 3D point cloud of the cross-domain dataset 604 to the feature extractor of the second trained OD 602 to generate the respective cross-domain feature map 704; (2) feed the given training 3D point cloud to each one of the given source domain-specific OD 512 and the at least one other source-domain specific OD 514 to generate the respective plurality of domain-specific feature maps 706; and (3) optimize a difference between the respective cross-domain feature map 704 and each one of the respective plurality of domain-specific feature maps 706, thereby generating a respective adapted cross-domain feature map (not depicted).

In some non-limiting embodiments of the present technology, to generate the respective plurality of domain-specific feature maps 706, the server 23 can further be configured to use the feature extractor of the second trained OD 602, resulted from the second stage of the training pipeline, which is configured to detect the objects in the target domain. More specifically, in these embodiments, the server 23 can be configured to: (i) generate a replica second trained OD 608 of the second trained OD 602; and (ii) along with feeding the given training 3D point cloud of the cross-domain dataset 604 to the feature extractors of the source domain-specific ODs, as mentioned above, feed the given training 3D point cloud to the feature extractor of the replica second trained OD 602, thereby generating the respective plurality of domain-specific feature maps 706 for further use for adapting of the respective cross-domain feature map 704. Thus, while parameters of the second trained OD 602 during the execution of the third stage of the training pipeline are adjusted by optimizing the loss functions and the difference between the respective cross-domain feature map 704 and each one of the respective plurality of domain-specific feature maps 706, parameters of the replica second trained OD 608 remain unchanged (or otherwise “frozen”). For example, in those embodiments where the OD 402 is initially a CenterPoint-based neural network, such parameters can be node weights of the neural network.

Thus, by optimizing the difference between the respective cross-domain feature map 704 and each one of the respective plurality of domain-specific feature maps 706 for each training 3D point cloud of the cross-domain dataset 604, the server 23 can be configured to train the feature extractor of the second trained OD 602 to generate the adapted cross-domain feature maps, which the server 23 can further be configured to feed to the detection head (not separately labelled) of the second trained OD 602 to train the detection head to detect the objects in the at least one source domain and the target domain, thereby generating the cross-domain OD 702.

According to certain non-limiting embodiments of the present technology, the difference between the respective cross-domain feature map 704 and the respective plurality of domain-specific feature maps can be expressed by a cross-domain feature loss function. In some non-limiting embodiments of the present technology, the cross-domain feature loss function can be a Mean Square Error loss between the respective cross-domain feature map 704 and each one of the respective plurality of domain-specific feature map, expressed, for example, by a following equation:

$${ℒ}_{ukt} = {\sum }_{l = 1}^{t} {‖ {f}_{0} - {f}_{l} ‖}^{2} , \qquad ( 3 )$$

where f₀ is the respective cross-domain feature map 704;
   fₗ is a given one of the respective plurality of domain-specific feature maps 706; and
   t is a number of domain-specific feature maps in the respective plurality of domain-specific feature maps 706, that is, a number of domain-specific ODs used for execution of the third stage of the training pipeline.

Further, the server 23 can be configured to feed the so generated adapted cross-domain feature maps to the detection head of the second trained OD 602 to train the detection head of the second trained OD 602 to detect the objects in both the at least one source domain and the target domain. To that end, as mentioned hereinabove with respect to the first and second stages of the training pipeline, the server 23 can be configured to optimize both the regression and classification loss functions.

Thus, to generate the cross-domain OD 702 by executing the third stage of the training pipeline of the OD 402 in accordance with the embodiments thereof depicted in FIG. 6B, the server 23 can be configured to simultaneously optimize: (1) the regression loss function; (2) the classification loss function; and (3) the cross-domain feature loss function.

However, with continued reference to FIG. 6B, in some non-limiting embodiments of the present technology, the server 23 can be configured to train the feature extractor of the second trained OD 602 to generate the adapted cross-domain feature maps by applying an adapting procedure 606 to the respective cross-domain feature map 704.

With reference to FIG. 7, there is depicted a schematic diagram of the adapting procedure 606, in accordance with certain non-limiting embodiments of the present technology.

First, according to certain non-limiting embodiments of the present technology, the server 23 can be configured to generate, based on the respective cross-domain feature map 704, a respective channel-adaptive feature map 710. To that end, in some non-limiting embodiments of the present technology, first, the server 23 can be configured to apply to the respective cross-domain feature map 704 a pooling operation 708 to generate channel-wise adaptive weights. However, in other non-limiting embodiments of the present technology, to generate the channel-wise adaptive weights, after applying the pooling operation 708, the server 23 can be configured to further apply to the respective cross-domain feature map 704 at least one of: (i) a multi-layer perceptron (MLP, not separately numbered), which, in the embodiments where the OD 402 is the CenterPoint-based neural network, can comprise multiple fully-connected layers; and (ii) a sigmoid function (not separately numbered). In other words, in these embodiments, the channel-wise adaptive weights can be determined in accordance with a following equation:

$$ω = σ ( MLP ( Pooling ( {f}_{0} ) ) ) . \qquad ( 4 )$$

Further, the server 23 can be configured to apply the so determined channel-wise adaptive weights to the respective cross-domain feature map 704 to generate the respective channel-adaptive feature map 710. More specifically, in some non-limiting embodiments of the present technology, to generate the respective channel-adaptive feature map 710, the server 23 can be configured to preform element-wise multiplication between elements of the respective cross-domain feature map 704 and the channel-wise adaptive weights, employing residual connection, for example, in accordance with an equation:

$${f}_{0}^{c} = {f}_{0} + ω ⊙ {f}_{0} . \qquad ( 5 )$$

In some non-limiting embodiments of the present technology, the server 23 can further be configured to apply to the respective channel-adaptive feature map 710 a mask of training objects 712 in the given training 3D point cloud. To that end, in some non-limiting embodiments of the present technology, the server 23 can be configured to generate a heatmap of the training objects, for example, by applying to the respective channel-adaptive feature map 710 a convolutional layer (not depicted). In other words, the server 23 can be configured to generate the heatmap of the training objects in accordance with a following equation:

$$H = {Conv}_{h} ( {f}_{0}^{c} ) . \qquad ( 6 )$$

Further, to the so determined heatmap of the training objects, the server 23 can be configured to apply a sigmoid function, thereby generating the mask of training objects 712 in the given training 3D point cloud, which can be expressed by a following equation:

$$M = σ ( H ) . \qquad ( 7 )$$

However, it should be noted that, in other non-limiting embodiments of the present technology, the mask of training objects 712 in the given training 3D point cloud can be defined by one of the corresponding label and the corresponding pseudo label associated therewith.

Further, to apply the mask of training objects 712 to the respective channel-adaptive feature map 710, the server 23 can be configured to perform element-wise multiplication between the elements thereof, thereby highlighting the training objects of the given training 3D point cloud in the respective channel-adaptive feature map 710.

Further, in accordance with certain non-limiting embodiments of the present technology, the server 23 can be configured to apply to the respective channel-adaptive feature map 710 a plurality of convolutional layers 714 to generate a plurality of adapted object-aware feature maps 716. In some non-limiting embodiments of the present technology, each on of the plurality of convolutional layers 714 corresponds to a respective one of the respective plurality of domain-specific feature maps 706. For example, in those embodiments where the mask of training objects 712 is applied first to the respective channel-adaptive feature map 710, further application thereto of the plurality of convolutional layers 714 to generate the plurality of adapted object-aware feature maps 716 can be expressed by a following equation:

$$= {Conv}_{l} ( M ⊙ {f}_{0}^{c} ) , \qquad ( 8 )$$

where [symbol] for is a given one of the plurality of adapted object-aware feature maps 716; and
   M is the mask of the training objects 712 in the given training 3D point cloud.

Thus, to train the feature extractor of the second trained OD 602 to generate the adapted cross-domain feature maps, the server 23 can be configured to optimize a difference between each one of the respective plurality of domain-specific feature maps 706 and a respective one of the plurality of adapted object-aware feature maps 716. To do so, the server 23 can be configured to optimize the cross-domain feature loss function of Equation (3), as an example.

In some non-limiting embodiments of the present technology, prior to training the feature extractor of the second trained OD 602, the server 23 can be configured to apply a respective domain-specific mask (not separately numbered) of training objects to each one of the plurality of adapted object-aware feature maps 716. In some non-limiting embodiments of the present technology, similar to the mask of training objects 712, the respective domain-specific mask can be defined by the one of the corresponding label and the corresponding pseudo label associated with the given training 3D point cloud, that is, be a replica of the mask of training objects 712.

However, similar to generating the mask of training objects 712 in the other non-limiting embodiments of the present technology, the server 23 can be configured to generate the respective domain-specific mask for each one of the plurality of adapted object-aware feature maps 716 by: (i) generating a respective domain-specific heatmap for each one of the respective plurality of domain-specific feature maps 706; and (ii) applying the sigmoid functions to the respective domain-specific heatmap. Further, the server 23 can be configured to apply the respective domain-specific mask to the given domain-specific feature map of the respective plurality of domain-specific feature maps 706, thereby generating a respective object-aware domain-specific feature map 718 of a respective plurality of object-aware domain-specific feature maps. Similarly, the server 23 can be configured to apply the respective domain-specific mask to the given domain-specific feature map by performing an element-wise multiplication of the elements thereof, such as in accordance with a following equation:

$${\tilde{f}}_{l} = {M}_{l} ⊙ {f}_{l}^{c} , \qquad ( 9 )$$

where \tilde{f}ₗ is the respective object-aware domain-specific feature map 718 of the respective plurality of object-aware domain-specific feature maps;
   Mₗ is the respective domain-specific mask; and
   fₗ^{c} is the given domain-specific feature map of the respective plurality of domain-specific feature maps 706.

Thus, to train the feature extractor of the second trained OD 602 to generate the adapted cross-domain feature maps, in these embodiments, the server 23 can be configured to optimize a difference between each one of the respective plurality of object-aware domain-specific feature maps and the respective one of the plurality of adapted object-aware feature maps 716. To do so, the server 23 can be configured to optimize the cross-domain feature loss function of Equation (3), as an example.

In some non-limiting embodiments of the present technology, the server 23 can be configured to train the feature extractor of the second trained OD 602 to generate the adapted cross-domain feature maps by further optimizing a difference between the mask of training objects 712 associated with the respective cross-domain feature map 704 and each domain-specific masks associated with the respective plurality of domain-specific feature maps 706. For example, this difference can be expressed by a mask consistency loss function, which analytically can be defined as follows:

$${ℒ}_{mc} = {\sum }_{l = 1}^{t} {‖ M - {M}_{l} ‖}^{2} . \qquad ( 10 )$$

Further, as mentioned above, using the adapted cross-domain feature maps, the server 23 can be configured to further train the detection head of the second trained OD 602 to detect the objects in both the at least one source domain and the target domain.

Thus, in certain non-limiting embodiments of the present technology, to train the second trained OD 602 to detect the objects in the at least one source domain and the target domain, thereby generating the cross-domain OD 702, the server 23 can be configured to simultaneously optimize each one of: (i) the regression loss function; (ii) the classification loss function; (iii) the cross-domain feature loss function; and (iv) the mask consistency loss function.

It should be noted that the server 23 is configured to apply the adapting procedure 606 described above only for training the feature extractor of the second trained OD 602 to generate the adapted cross-domain feature maps; and as such, the adapting procedure 606 can be omitted during using the cross-domain OD 702 for detecting objects in the 3D point clouds.

With back reference to FIGS. 6A and 6B, in some non-limiting embodiments of the present technology, instead of feeding an entirety of the cross-domain dataset 604 to the second trained OD 602 for the training thereof as described above, the server 23 can be configured to sample training 3D point clouds from the cross-domain dataset 604, and use only the sampled training 3D point clouds for training the second trained OD 602. In some non-limiting embodiments of the present technology, the server 23 can be configured to sample the training 3D point clouds using uniform sampling, that is, sampling, for example, every tenth, twentieth, fortieth, or hundredth training 3D point cloud from the cross-domain dataset 604. However, other sampling approaches, such as random sampling or representative example sampling can also be used by the server 23 without departing from the scope of the present technology.

Thus, the cross-domain OD 702 trained in accordance with multiple embodiments of the present technology described above can further be used for detecting the objects in the 3D point clouds, such as the given surrounding object 206 in the given 3D point cloud 204. The given 3D point cloud 204 can be of one of the plurality of domains, that is, generated in various geographical locations, in various weather conditions, or by various configurations of the imaging system 18, used for generating the training 3D point clouds for generating the cross-domain OD 702.

As it can be appreciated, certain embodiments of the method 300 allow generating the cross-domain OD 702 using the unlabelled target domain dataset 506 and transferring knowledge within the plurality of source domains and the target domain, which may increase the efficiency of the training pipeline and accuracy of object detection of the cross-domain OD 702.

It should be expressly understood that although the embodiments of the method 300 described above are directed to training the OD 402 to detect the objects in the 3D point clouds; the server 23 can similarly be trained, mutatis mutandis, to detect the objects in other types of the image data, including, other types of 3D image data, such as 3D mesh, for example; or 2D image data, such as 2D RGB images, for example.

The method 300 hence terminates.

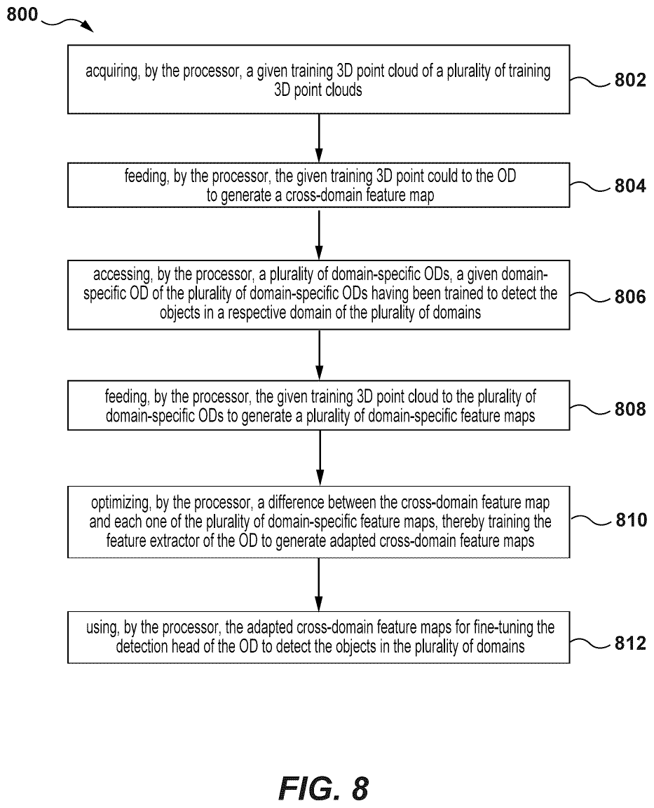

Given an architecture and examples provided hereinabove, it is now possible to implement another method of fine-tuning an OD, such as the second trained OD 602, pre-trained as described above with respect to FIGS. 4A to 5B, to detect the objects in the plurality of domains. With reference to FIG. 8, there is depicted a flowchart diagram of a second method 800, in accordance with certain non-limiting embodiments of the present technology. The second method 800 can be executed, for example, by the server 23.

### Step 802: Acquiring, by the Processor, a Given Training 3D Point Cloud of a Plurality of Training 3D Point Clouds

The second method 800 commences at step 802 with the server 23 being configured to acquire a training dataset for fine-tuning the second trained OD 602. For example, the server 23 can be configured acquire the cross-domain dataset 604 generated as described above with reference to FIGS. 6A and 6B.

As mentioned above, in some non-limiting embodiments of the present technology, the cross domain dataset 604 includes training 3D point clouds, each one of which is of a respective one of the at least one source domain and the target domain. Further, the given training 3D point cloud has been assigned with the one of the corresponding label and the corresponding pseudo label indicative of the respective location and the respective object class of the at least one training object in the given training 3D point cloud, as described above with reference to FIGS. 5A and 5B.

The second method 800 hence advances to step 804.

Step 804: Feeding, by the Processor, the Given Training 3D Point could to the OD to Generate a Cross-Domain Feature Map

At step 804, as described above with reference to FIG. 6B, the server 23 can be configured to feed the given training 3D point cloud to the feature extractor of the second trained OD 602 to generate the respective cross-domain feature map 704.

The second method thus proceeds to step 806.

Step 806: Accessing, by the Processor, a Plurality of Domain-Specific ODS, a Given Domain-Specific OD of the Plurality of Domain-Specific ODS Having been Trained to Detect the Objects in a Respective Domain of the Plurality of Domains

At step 806, the server 23 can be configured to access (or otherwise generate, as described above) a plurality of domain-specific ODs, including, for example, at least one of: the given source domain-specific OD 512, the at least one other source domain-specific OD 514, and the replica second trained OD 608. Each one of the given source domain-specific OD 512, the at least one other source domain-specific OD 514, and the replica second trained OD 608 have been trained to detect the objects in specific domains, that is, the given source domain, the at least one other source domain, and the target domain, respectively.

The second method 800 thus proceeds to step 808.

### Step 808: Feeding, by the Processor, the Given Training 3D Point Cloud to the Plurality of Domain-Specific ODS to Generate a Plurality of Domain-Specific Feature Maps

At step 808, as described above with reference to FIGS. 6B and 7, the server 23 can be configured to feed the given training 3D point cloud to each one of the given source domain-specific OD 512, the at least one other source domain-specific OD 514, and the replica second trained OD 608, thereby generating the respective plurality of domain-specific feature maps 706.

The second method 800 hence advances to step 810.

### Step 810: Optimizing, by the Processor, a Difference Between the Cross-Domain Feature Map and Each One of the Plurality of Domain-Specific Feature Maps, Thereby Training the Feature Extractor of the OD to Generate Adapted Cross-Domain Feature Maps

At step 810, as described above with reference to FIG. 6A, in some non-limiting embodiments of the present technology, the server 23 can be configured to optimize the difference between the respective cross-domain feature map 704 and each one of the respective plurality of domain-specific feature maps 706, thereby training the feature extractor of the second trained OD 602 to generate the adapted cross-domain feature maps. As mentioned further above, this difference can be expressed by the cross-domain feature loss function of Equation (3).

In other non-limiting embodiments of the present technology, to train the feature extractor of the second trained OD 602 to generate the adapted cross-domain feature maps, the server 23 can be configured to apply the adapting procedure 606 described in detail above with reference to FIGS. 6B and 7.

The second method 800 hence advances to step 812.

### Step 812: Using, by the Processor, the Adapted Cross-Domain Feature Maps for Fine-Tuning the Detection Head of the OD to Detect the Objects in the Plurality of Domains

At step 812, the server 23 can be configured to use the so generated adapted cross-domain feature maps for training the detection head of the second trained OD 602 to detect the object in both the at least one source domain and the target domain, thereby generating the cross-domain OD 702, as described in detail above.

The second method 800 hence terminates.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implementable method for training an Object Detector (OD) to detect objects in 3D point clouds, the method being executable by a server including a processor, the method comprising:
during a first stage of a training pipeline:
training, by the processor, the OD using a source domain dataset to detect the objects in a source domain, thereby generating a first trained OD,
the source domain dataset comprising a first plurality of training 3D point clouds and corresponding training labels;
during a second stage of the training pipeline:
training, by the processor, the first trained OD using a target domain dataset to detect the objects in a target domain, thereby generating a second trained OD,
the target domain dataset comprising a second plurality of training 3D point clouds and the corresponding training labels; and
during a third stage of the training pipeline:
generating, by the processor, a cross-domain dataset using at least one 3D point cloud and the corresponding training label from the source domain dataset and at least one 3D point cloud and the corresponding training label from the target domain dataset; and
training, by the processor, the second trained OD using the cross-domain dataset to detect objects in both the source domain and the target domain, thereby generating a cross-domain OD.

2. The method of claim 1, wherein:
during the first stage of the training pipeline, the method further comprises:
acquiring, by the processor, an other source domain dataset from an other source domain, different from the source domain;
generating, by the processor, a combined source domain dataset including at least one training 3D point cloud from the source domain dataset and at least one training 3D point cloud from the other source domain dataset; and
wherein the generating the first trained OD comprises training the OD using the combined source domain dataset to detect the objects in each one of the source domain and the other source domain.

3. The method of claim 1, wherein during the second stage of the training pipeline, prior to the training, the method comprises:
acquiring, by the processor, an unlabelled target domain dataset including a third plurality of training 3D point clouds devoid of the corresponding training labels;
feeding, by the processor, each training 3D point cloud of the unlabelled target domain dataset to the first trained OD to generate, for each training 3D point cloud of the unlabelled target domain dataset, a corresponding training pseudo label, thereby generating a pseudo-labelled target domain dataset;
generating, by the processor, a combined target domain dataset including at least one training 3D point cloud and the corresponding training label from the target domain dataset and at least one training 3D point cloud and the corresponding training pseudo label from the pseudo-labelled target domain dataset; and
wherein the generating training the second trained OD comprises training, by the processor, the first trained OD using the combined target domain dataset for detecting the objects in the target domain.

4. The method of claim 3, wherein the generating the second trained OD comprises training the first trained OD using both (i) the combined target domain dataset; and (ii) at least one training 3D point cloud data and the corresponding label from the source domain dataset to detect the objects in the target domain.

5. The method of claim 3, wherein:
during the first stage of the training pipeline, the method further comprises:
acquiring, by the processor, an other source domain dataset from an other source domain, different from the source domain;
generating, by the processor, a combined source domain dataset including at least one training 3D point cloud from the source domain dataset and at least one training 3D point cloud from the other source domain dataset; and
wherein the generating the second trained OD comprises training the first trained OD using both (i) the combined target domain dataset; and (ii) at least one training 3D point cloud data and the corresponding label from the combined source domain dataset to detect the objects in the target domain.

6. The method of claim 1, wherein the OD comprises: (i) a feature extractor configured to generate, based on a given 3D point cloud fed thereto, a respective feature map representative of at least one object captured by the given 3D point cloud; and (ii) a detection head to be trained to detect, based on the respective feature map, the at least one object captured by the given 3D point cloud.

7. The method of claim 6, wherein the OD is a CenterPoint-based neural network.

8. The method of claim 6, wherein:
during the first stage of the training pipeline, the method further comprises:
training, by the processor, the OD using the source domain dataset for detecting the objects in the source domain, thereby generating a trained source domain-specific OD;
acquiring, by the processor, an other source domain dataset from an other source domain, different from the source domain;
training, by the processor, an other OD using the other source domain dataset for detecting the objects in the other source domain, thereby generating an other trained source domain-specific OD;
generating, by the processor, a combined source domain dataset including at least one training 3D point cloud from the source domain dataset and at least one training 3D point cloud from the other source domain dataset; and
wherein the generating the first trained OD comprises training the OD using the combined source domain dataset to detect the objects in each one of the source domain and the other source domain;
during the third stage of the training pipeline, prior to the training, the method comprises:
generating, by the processor, for a given training 3D point cloud from the cross-domain dataset, a plurality of domain-specific feature maps by applying to the given training 3D point cloud the feature extractors of each one of the trained source domain-specific OD and the other source domain-specific OD;
generating, by the processor, for the given training 3D point cloud from the cross-domain dataset, a cross-domain feature map by applying, by the processor, to the given training 3D point cloud the feature extractor of the second trained OD; and
wherein the training the second trained OD, thereby generating the cross-domain OD, is further based on a comparison between the cross-domain feature map and each one of the plurality of domain-specific feature maps.

9. A computer-implementable method of fine-tuning an Object Detector (OD) having been pre-trained to detect objects in 3D point clouds, in a plurality of domains, the OD comprising: (i) a feature extractor having been pre-trained to generate, based on a given 3D point cloud, a feature map; and (ii) a detection head having been pre-trained, based on the feature map, to detect the objects in the given 3D point cloud, the method being executable by a server including a processor, the method comprising:
acquiring, by the processor, a given training 3D point cloud of a plurality of training 3D point clouds;
feeding, by the processor, the given training 3D point could to the OD to generate a cross-domain feature map;
accessing, by the processor, a plurality of domain-specific ODs, a given domain-specific OD of the plurality of domain-specific ODs having been trained to detect the objects in a respective domain of the plurality of domains;
feeding, by the processor, the given training 3D point cloud to the plurality of domain-specific ODs to generate a plurality of domain-specific feature maps;
optimizing, by the processor, a difference between the cross-domain feature map and each one of the plurality of domain-specific feature maps, thereby training the feature extractor of the OD to generate adapted cross-domain feature maps; and
using, by the processor, the adapted cross-domain feature maps for fine-tuning the detection head of the OD to detect the objects in the plurality of domains.

10. The method of claim 9, wherein the training the feature extractor of the OD to generate the adapted cross-domain feature maps comprises:
applying, by the processor, to the cross-domain feature map a pooling operation to generate channel-wise adaptive weights;
applying, by the processor, the channel-wise adaptive weights to the cross-domain feature map to generate a channel adaptive feature map;
applying, by the processor, to the channel adaptive feature map, a plurality of convolutional layers to generate a plurality of adapted object-aware feature maps, each one of which corresponds to a respective domain-specific feature map of the plurality of domain-specific feature maps; and
optimizing, by the processor, a difference between a given one of the plurality of adapted object-aware feature maps and the respective domain-specific feature map, thereby training the OD to generate the adapted cross-domain feature maps.

11. The method of claim 10, wherein, prior to the applying the plurality of convolutional layers, the method further comprises:
generating, by the processor, a heatmap of training objects in the given training 3D point cloud;
applying, by the processor, to the heatmap of training objects, a convolutional layer to generate a mask of training objects in the given training 3D point cloud; and
applying, by the processor, the mask of training objects to the channel adaptive feature map to highlight the training objects therein.

12. The method of claim 11, wherein the generating the heatmap comprises feeding the channel adaptive feature map to the detection head of OD.

13. The method of claim 12, further comprising:
generating, by the processor, a respective domain-specific heatmap for each one of the plurality of domain-specific feature maps;
generating, by the processor, based on the respective heatmap, a respective domain-specific mask of training objects in the given training 3D point cloud; and
wherein the training the feature extractor further comprises optimizing, by the processor, a difference between the mask associated with the respective cross-domain feature map and each one of respective domain-specific masks.

14. The method of claim 9, wherein the OD is a CenterPoint-based neural network.

15. A server for fine-tuning an Object Detector (OD) having been pre-trained to detect objects in 3D point clouds, in a plurality of domains, the OD comprising: (i) a feature extractor having been pre-trained to generate, based on a given 3D point cloud, a feature map; and (ii) a detection head having been pre-trained, based on the feature map, to detect the objects in the given 3D point cloud, the server comprising a processor and a non-transitory computer-readable medium storing instructions, and the processor, upon executing the instructions, being configured to:
acquire a given training 3D point cloud of a plurality of training 3D point clouds;
feed the given training 3D point could to the OD to generate a cross-domain feature map;
access a plurality of domain-specific ODs, a given domain-specific OD of the plurality of domain-specific ODs having been trained to detect the objects in a respective domain of the plurality of domains;
feed the given training 3D point cloud to the plurality of domain-specific ODs to generate a plurality of domain-specific feature maps;
optimize a difference between the cross-domain feature map and each one of the plurality of domain-specific feature maps, thereby training the feature extractor of the OD to generate adapted cross-domain feature maps; and
use the adapted cross-domain feature maps for fine-tuning the detection head of the OD to detect the objects in the plurality of domains.

16. The server of claim 15, wherein to train the feature extractor of the OD to generate the adapted cross-domain feature maps, the processor is configured to:
apply, to the cross-domain feature map a pooling operation to generate channel-wise adaptive weights;
apply the channel-wise adaptive weights to the cross-domain feature map to generate a channel adaptive feature map;
apply, to the channel adaptive feature map, a plurality of convolutional layers to generate a plurality of adapted object-aware feature maps, each one of which corresponds to a respective domain-specific feature map of the plurality of domain-specific feature maps; and
optimize a difference between a given one of the plurality of adapted object-aware feature maps and the respective domain-specific feature map, thereby training the OD to generate the adapted cross-domain feature maps.

17. The server of claim 16, wherein, prior to applying the plurality of convolutional layers, the processor is further configured to:
generate a heatmap of training objects in the given training 3D point cloud;
apply, to the heatmap of training objects, a convolutional layer to generate a mask of training objects in the given training 3D point cloud; and
apply the mask of training objects to the channel adaptive feature map to highlight the training objects therein.

18. The server of claim 17, wherein to generate the heatmap, the processor is configured to feed the channel adaptive feature map to the detection head of OD.

19. The server of claim 18, wherein the processor is further configured to:
generate a respective domain-specific heatmap for each one of the plurality of domain-specific feature maps;
generate, based on the respective heatmap, a respective domain-specific mask of training objects in the given training 3D point cloud; and
wherein to train the feature extractor, the processor is further configured to optimize a difference between the mask associated with the respective cross-domain feature map and each one of respective domain-specific masks.

20. The server of claim 15, wherein the OD is a CenterPoint-based neural network.
